(19) United States
(12) Patent Application Publication
(10) Pub. No.: US 2009/0176162 A1
(43) Pub. Date: Jul. 9, 2009

(54) LITHIUM RECHARGEABLE ELECTROCHEMICAL CELL

(76) Inventors: Ivan Exnar, Itingen (CH); Qing Wang, Ecublens (CH); Michael Gratzel, St-Sulpice (CH); Shaik Mohammed Zakeeruddin, Renens (CH); Ladislav Kavan, Praha (CZ)

Correspondence Address: NIXON & VANDERHYE, PC, 901 NORTH GLEBE ROAD, 11TH FLOOR, ARLINGTON, VA, 22203, US

(21) Appl. No.: 12/296,211

(22) PCT Filed: Apr. 6, 2007
(86) PCT No.: PCT/IB2007/051246

§ 371 Date: Dec. 8, 2008

(30) Foreign Application Priority Data
Apr. 7, 2006 (EP) 06112361.8
Oct. 18, 2006 (IB) PCT/IB2006/053832
Oct. 18, 2006 (IB) PCT/IB2006/053833

(51) Int. Cl. H01M 6/16; H01M 4/60; H01M 4/62; H01M 4/52; H01M 4/50; H01M 4/58; H01M 4/48

(52) U.S. Cl. 429/336; 429/324; 429/341; 429/213; 429/217; 429/221; 429/223; 429/224; 429/231.1; 429/231.2; 429/231.3; 429/231.5; 429/231.95; 977/773

(57) ABSTRACT

This invention concerns a lithium rechargeable electrochemical cell containing electrochemical redox active compounds in the electrolyte. The cell is composed of two compartments, where the cathodic compartment comprises a cathodic lithium insertion material and one or more of p-type redox active compound(s) in the electrolyte; the anodic compartment comprises an anodic lithium insertion material and one or more of n-type redox active compound(s) in the electrolyte. These two compartments are separated by a separator and the redox active compounds are confined only in each compartment. Such a rechargeable electrochemical cell is suitable for high energy density applications. The present invention also concerns the general use of redox active compounds and electrochemically addressable electrode systems containing similar components which are suitable for use in the electrochemical cell.

### FIELD OF THE INVENTION

This invention concerns electrochemically addressable lithium insertion electrode systems for electrochemical cells using non-aqueous organic electrolytes, quasi-solid gel electrolytes, solid electrolytes, or the like and in particular the use of said electrolytes in combination with porous electrode materials, i.e. doped or non-doped nanoparticles or sub-microparticles of lithium insertion materials and redox active compounds in the electrolyte. This invention also concerns the configuration of the electrochemical cell containing the redox active compounds.

### STATE OF THE ART

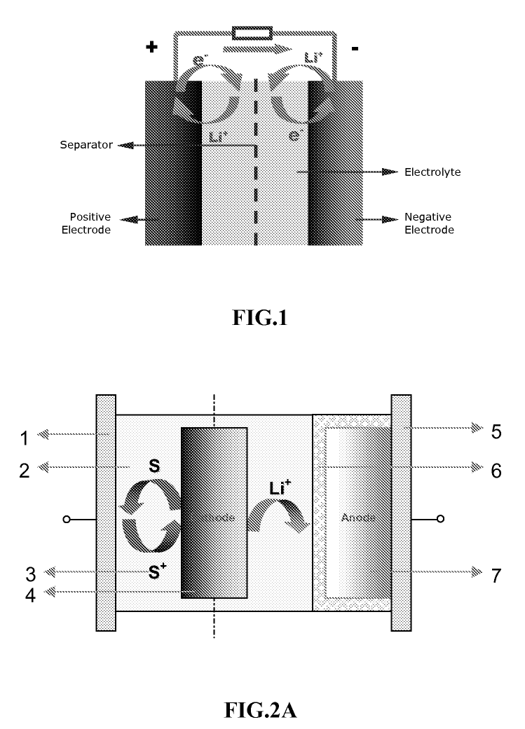

Electrochemical cells, as illustrated in FIG. 1, have used lithium insertion materials by adding conductive additive, i.e. carbon black, carbon fiber, graphite, or mixture of them to improve the electronic conductivity of the electrode films.

The lithium insertion materials in commercial electrochemical cells comprise 2˜25 wt. %, typically 10 wt. % conductive additives. These conductive agents do not participate in the redox reactions and therefore represent inert mass reducing the specific energy storage capacity of the electrode. This situation is especially severe as the lithium insertion material or its de-intercalated state has very poor electronic conductivity.

For instance, pioneering work by Padhi et al (J. Electrochem. Soc. 144, 1188 (1997).) first demonstrated reversible extraction of Li from the olivine-structured LiFePO₄, however 25 wt. % acetylene black was added. This is also illustrated in JP 2000-294238 A2 wherein a LiFePO₄/Acetylene Black ratio of 70/25 is used.

U.S. Pat. No. 6,235,182 and WO Pt. No. 9219092 disclose a method for coating insulators with carbon particles by substrate-induced coagulation. This method involves the adsorption of polyelectrolyte compound and subsequent coagulation of carbon particle on the substrate to form an adhesive carbon coating. For high quality carbon coating, the size of carbon particle is very dependent on the dimension of substrate and the amount of carbon used is still remarkable.

International patent application WO 2004/001881 discloses a new route for the synthesis of carbon-coated powders having the olivine or NASICON structure by mixing the precursors of carbon and said materials and subsequent calcinations. Nevertheless, it is still necessary to have 4˜8 wt. % of coated carbon to exploit the invention fully.

### SUMMARY OF THE INVENTION

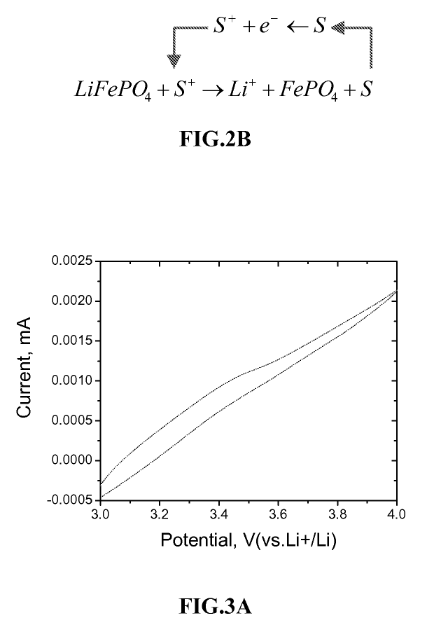

It has been discovered that the presence of some redox active compounds in the electrolyte forms an electrochemically addressable electrode system. As illustrated in FIG. 2, for a cathodic lithium insertion material and a p-type redox active compound (S) dissolved in the electrolyte of cathodic compartment, upon positive polarization the p-type redox active compound will be oxidized at current corrector and charges (holes) will be transported from the current collector to the lithium insertion material by the diffusion of the oxidized p-type redox active compound (S+). As the redox potential of the p-type redox active compound is higher or matches closely the Fermi level of the lithium insertion material, S+ will be reduced by the lithium insertion material. Electrons and lithium ions will be withdrawn from it during battery charging. By contrast, during the discharging process, the oxidized species are reduced at current collector and charges (electrons) are transported from the current collector to the lithium insertion material by the diffusion of p-type redox active compound (S). Lithium ions and electrons are injected into the solid, as the redox potential of the p-type redox active compound is lower or matches closely the Fermi level of the lithium insertion material.

The cell is composed of two compartments, where the cathodic compartment comprises a cathodic lithium insertion material and p-type redox active compound(s) in the electrolyte; the anodic compartment comprises an anodic lithium insertion material and n-type redox active compound(s) in the electrolyte. These two compartments are separated by a separator and the redox active compounds are confined only in each compartment.

Compared to the whole electrode system, the redox active compounds do not occupy any extra volume of the whole electrode system. Hence with respect to prior art, the present invention allows reducing greatly the volume of the conductive additives resulting in a much improved energy storage density.

It is therefore an object of the invention to provide a means to avoid or minimize the amount of the conductive additives required for the operation of an ion insertion battery. It is also an object of the invention to provide a rechargeable electrochemical cell having higher energy density.

The invention relates therefore to a rechargeable electrochemical cell as defined in the claims.

### DEFINITIONS

As used herein, the term “lithium insertion material” refers to the material which can host and release lithium or other small ions such as Na⁺, Mg²⁺ reversibly. If the materials lose electrons upon charging, they are referred to as “cathodic lithium insertion material”. If the materials acquire electrons upon charging, they are referred to as “anodic lithium insertion material”.

As used herein, the term “p-type redox active compound” refers to those compounds that present in the electrolyte of cathodic compartment of the cell, and act as molecular shuttles transporting charges between current collector and cathodic lithium insertion material upon charging/discharging. On the other hand, the term “n-type redox active compound” refers to the molecules that present in the electrolyte of anodic compartment of the cell, and act as molecular shuttles transporting charges between current collector and anodic lithium insertion material upon charging/discharging.

### DETAILED DESCRIPTION OF THE INVENTION

The invention will be better understood below with a detailed description including different embodiments.

This is illustrated by the following figures

FIG. 1 shows a schematic sectional view of the prior art rechargeable electrochemical cell during discharging process.

FIG. 2A shows the schematic working principle of the electrochemical cell upon charging with p-type redox active compound in the cathodic compartment. 1: cathodic current collector; 2: electrolyte in cathodic compartment; 3: p-type redox active compound; 4: cathodic lithium insertion material; 5: anodic current collector; 6: separator; 7: anodic lithium insertion material.

FIG. 2B reactions involved in the cathodic compartment of the cell upon charging.

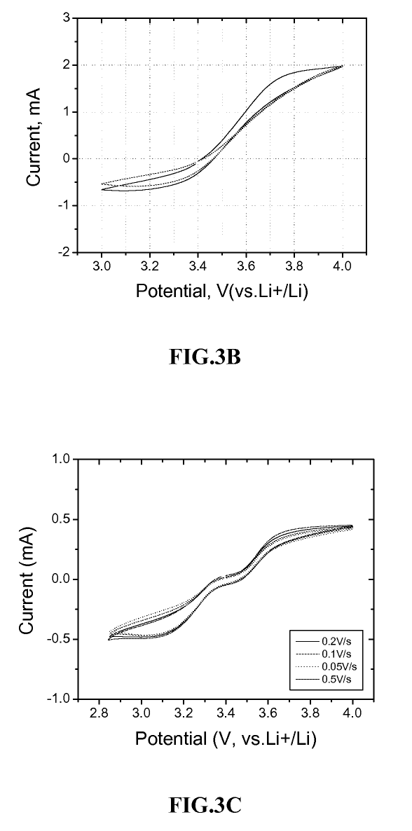

FIG. 3A shows cyclic voltammograms of bare LiFePO₄ electrode in ethylene carbonate (EC)+ethyl methyl carbonate (EMC)/1 M LiPF₆ electrolyte. The counter and reference electrodes are lithium foils. The scan rate is 5 mV/s.

FIG. 3B shows cyclic voltammograms of LiFePO₄ electrode in the presence of 0.1 M MPTZ in EC+EMC/1 M LiPF₆ electrolyte. The counter and reference electrodes are lithium foils. The scan rate is 5 mV/s.

FIG. 3C shows cyclic voltammograms of LiFePO₄ electrode in the presence of 4 mM Os(mobpy)₃Cl₂ and Os(mbpy)₃Cl₂ in EC+EMC/1 M LiPF₆ electrolyte. The counter and reference electrodes are lithium foils. The scan rates are indicated in the figure.

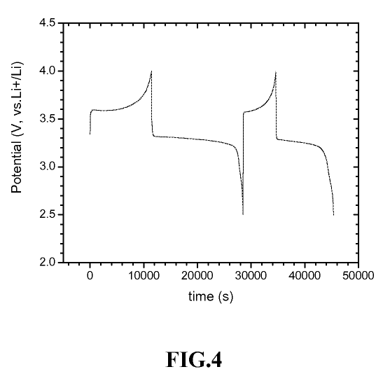

FIG. 4 shows the voltage profiles of LiFePO₄ electrode in the presence of 0.032 M Os(mobpy)₃Cl₂ and Os(mbpy)₃Cl₂ in EC+EMC/1 M LiPF₆ electrolyte. The current is 0.03 mA.

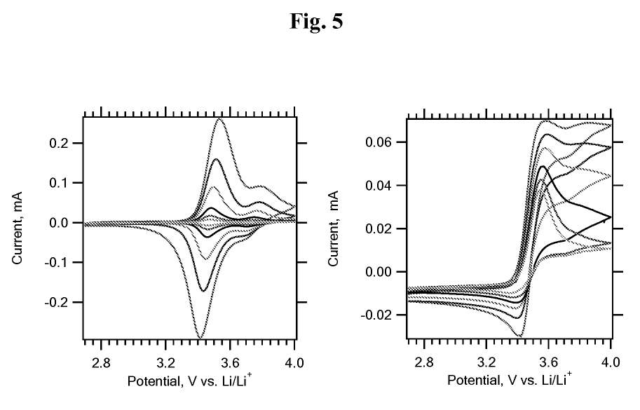

FIG. 5 Cyclic voltammograms (scan rates 20, 10, 5, 2, 1 and 0.5 mV/s); electrolyte solution 1 M LiPF₆ in EC/DMC. Left chart: pure PVP-POA(1/6) film (0.14 mg/cm²). Right chart electrode from LiFePO₄/PVP-POA(1/6) composite film (0.98 mg/cm²).

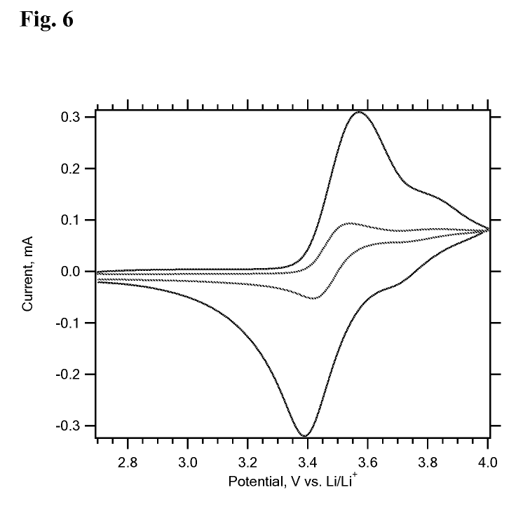

FIG. 6 Cyclic voltammograms (scan rate 50 mV/s); electrolyte solution 1 M LiPF₆ in EC/DMC. Red curve depicts the voltammogram of LiFePO₄/PVP-POA(1/6) composite film (0.98 mg/cm²). The current is normalized against the total mass of the active electrode materials, i.e. LiFePO₄/PVP-POA(1/6) composite film. Blue curve is for the pure polymer PVP-POA(1/6). In this case, the current is normalized against the mass of pure polymer in the composite.

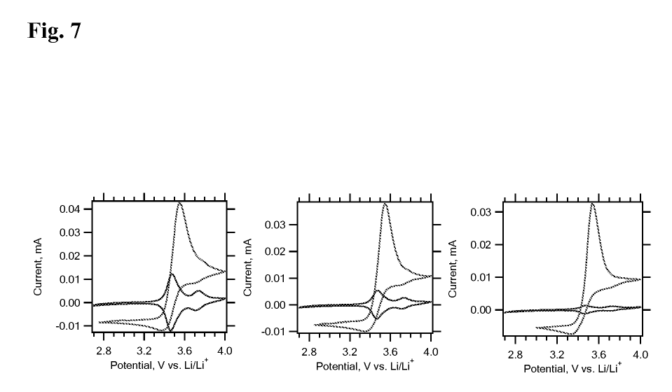

FIG. 7 Cyclic voltammograms (scan rates 1 mV/s, 0.5 mV/s and 0.2 mV/s for the charts from left to right); electrolyte solution 1 M LiPF₆ in EC/DMC. Red curve depicts the voltammogram of LiFePO₄/PVP-POA(1/6) composite film (0.98 mg/cm²). Blue curve is for the pure polymer PVP-POA(1/6). In this case, the current is normalized against the mass of pure polymer in the composite.

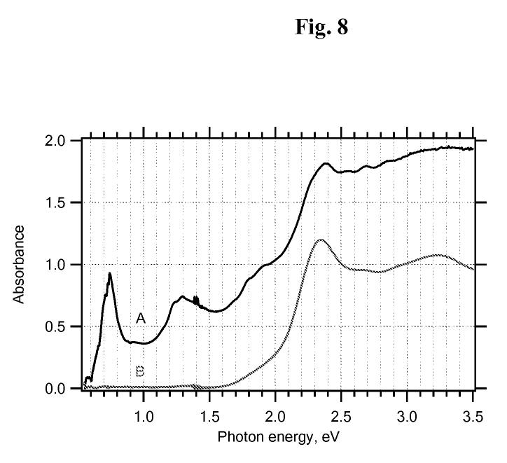

FIG. 8 Vis-NIR spectrum of the working solution of single wall carbon nanotubes dispersed by Ru-complex, Z-907Na/SWCNT (curve A) and pure Ru-complex Z-907Na (curve B). The concentration of Ru-complex was 6×10⁻⁴ mol/L in both cases, the optical cell thickness was 2 mm.

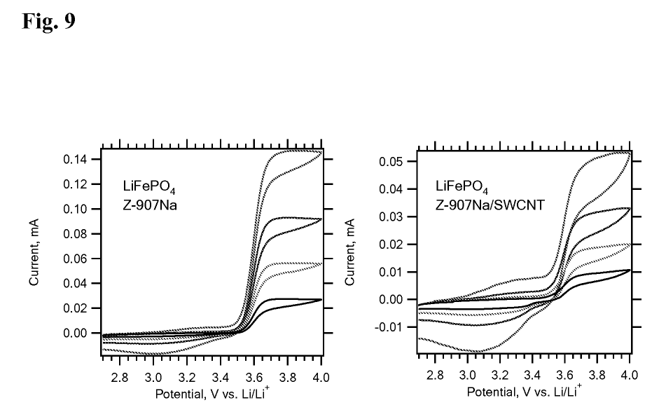

FIG. 9 Pure LiFePO₄ electrode (with 5% PVDF; total film mass 1.54 mg/cm²) treated by dip coating into 6·10⁻⁴ mol/L solution of Z-907Na (left chart) or Z-907Na/SWCNT (right chart). Scan rates (in mV/s): 50, 20, 10, 5 for curves from top to bottom. Electrolyte solution is 1 M LiPF₆ in EC/DMC.

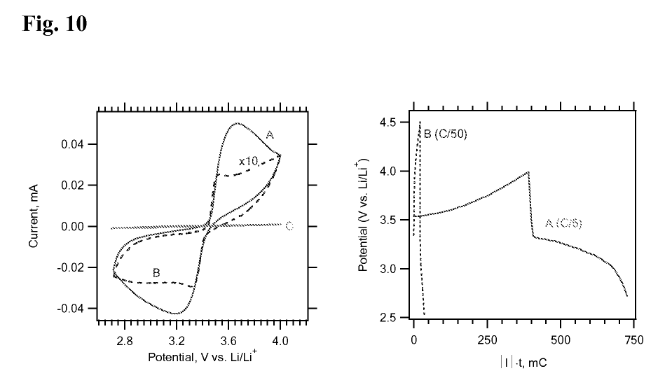

FIG. 10 Left chart: Cyclic voltammograms (scan rates 0.1 mV/s); electrolyte solution 1 M in EC/DMC. Curve A: Electrode from LiFePO₄ surface-derivatized with Z-907Na/SWCNT (2.04 mg/cm²). Curve B (dashed line): electrode from carbon-coated LiFePO₄ (Nanomyte BE-20, 2.28 mg/cm²). Curve C: Electrode from LiFePO₄ surface-derivatized with pyrene butanoic acid/SWCNT (1.83 mg/cm²). The current scale is multiplied by a factor of 10 for curve B.

Right chart: Galvanostatic charge/discharge cycle; electrolyte solution 1 M LiPF₆ in EC/DMC. Curve A: Electrode from LiFePO₄ surface-derivatized with Z-907Na/SWCNT mg/cm²) charging rate C/5. Curve B (dashed line): electrode from carbon-coated LiFePO₄ (Nanomyte BE-20, 2.28 mg/cm²) charging rate C/50.

FIGS. 1 to 4 refer to PART I of the detailed description

FIGS. 5 to 7 refer to PART II of the detailed description

FIG. 8 to 10 refer to PART III of the detailed description

### Part I: Redoxactive Compounds

As illustrated in FIG. 2A, a p-type redox active compound is dissolved in the electrolyte, which is confined in the cathodic compartment of the cell by a separator. Upon charging the cell, the p-type redox active compound will be oxidized at current corrector and charges (holes) will be transported from the current collector to the lithium insertion material by the diffusion of the oxidized p-type redox active compound (S+). This allows for electrochemical polarization of the whole particle network by the current collector even though the lithium insertion material is electronically insulating and no carbon additive is used to promote conduction. As the redox potential of the p-type redox active compound is higher or matches closely the potential of the lithium insertion material, S+ will be reduced by the lithium insertion material. Electrons and lithium ions will be withdrawn from it during battery charging as illustrated in FIG. 2B. By contrast, during the discharging process, the oxidized species are reduced at current collector and charges (electrons) are transported from the current collector to the lithium insertion material by the diffusion of p-type redox active compound (S). Lithium ions and electrons are injected into the solid, as the redox potential of the p-type redox active compound is lower or matches closely the potential of the lithium insertion material. More specifically during the charging of the battery, electrons and lithium ions are withdrawn from the lithium insertion compound while during the discharge process they are reinserted into the same material. An analogous mechanism is operative during discharging or charging of a lithium insertion material functioning as anode, the n-type redox active compound conducting electrons in this case.

The relevant materials used in the cathodic electrode system comprise a cathodic lithium insertion material and a p-type redox active compound dissolved in the electrolyte of the cathodic compartment.

Preferred Cathodic Lithium Insertion Materials used Herein are:

Doped or non-doped oxides LiMO₂ where M is one or more elements selected from M=Co, Ni, Mn, Fe, W, V, LiV₃O₈ or mix of them; phosphor-olivines as LiMPO₄ where M is one or more elements selected from M=Fe, Co, Mn, Ni, VO, Cr and mix of them and spinels and mixed spinels as LiₓMn₂O₄ or Li₂CoₓFe_{y}Mn_{z}O₈, etc., nano- or sub-microparticles. The particle size ranges from 10 nm to 10 micrometer, preferably 10˜1000 nm.

Preferred p-Type Redox Active Compounds have the Following Structure:

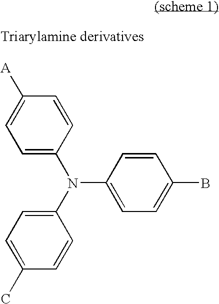

### A, B, C can be

### F or Cl or Br I or NO₂ or COOR or R or CF₃ or COR or OCH₃ or H

### R=Alkyl(C₁ to C₂₀)

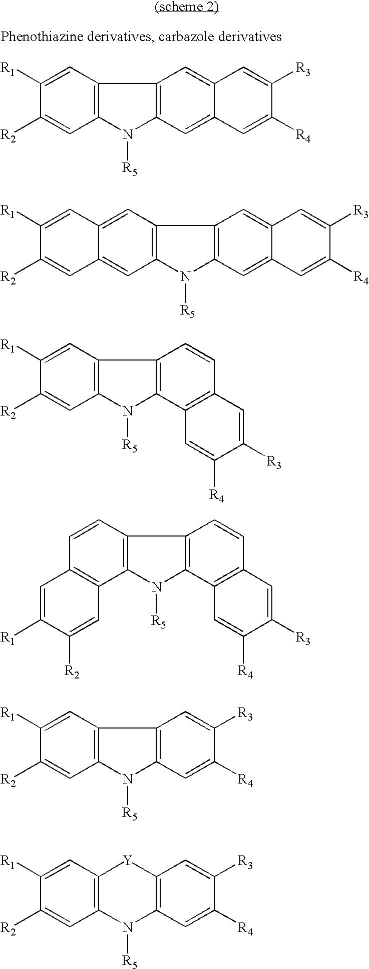

### Y═N or O or S

### R₁, R₂, R₃, R₄ can be

### F or Cl or Br or I or NO₂ or COOR or Alkyl(C₁ to C₂₀) or CF₃ or COR or OR₅ or H

### R₅=Alkyl(C₁ to C₂₀) or H

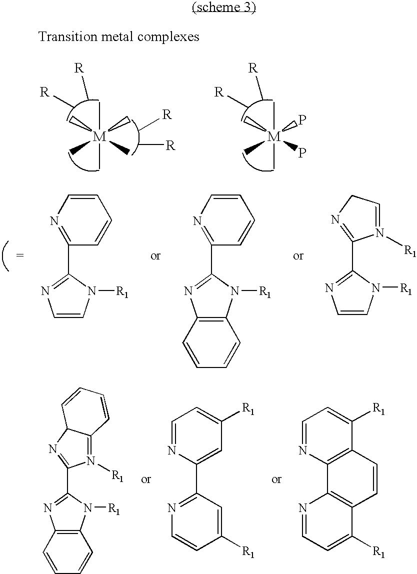

### M=Fe or Ru or Os

n=0 to 20

### R₁=COOR′ or COR′ or CF₃ or OR′ or NO₂ or F or Cl or Br or I or NR′₂ or R′

R′=alkyl(C₁ to C₂₀) or H

### P=F or Cl or Br or I or NO₂ or CN or NCSe or NCS or NCO

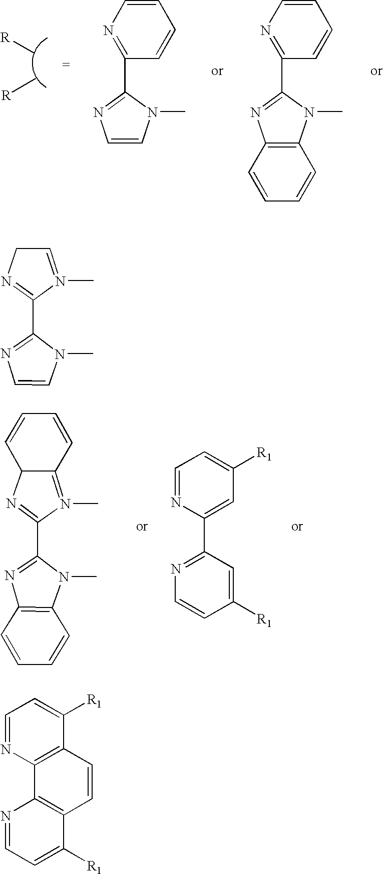

### R₁=COOR or COR or CF₃ or OR′ or NO₂ or F or Cl or Br or I or NR′₂ or R′

R′=alkyl(C₁ to C₂₀) or H

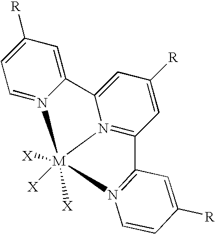

### M=Fe or Ru or Os

### X═F or Cl or Br or I or NO₂ or CN or NCSe or NCS or NCO

### R═F or Cl or Br or I or NO₂ or COOR′ or R′ or CF₃ or COR′ or OR′ or NR′₂

R′=alkyl(C₁ to C₂₀) or H

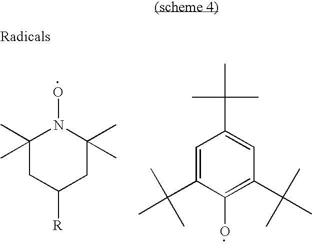

### R═F or Cl or Br or I or NO₂ or COOR′ or R′ or CF₃ or COR′ or OR′ or NR′₂

R′=alkyl(C₁ to C₂₀) or H

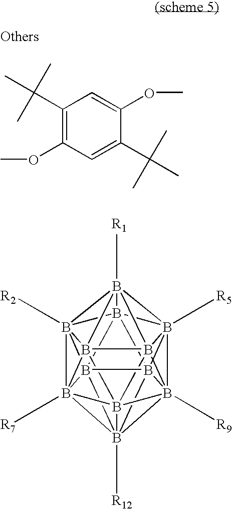

B₁₂R¹R²R³R⁴R⁵R⁶R⁷R⁸R⁹R¹⁰R¹¹R¹²
R¹, R², R³, R⁴, R⁵, R⁶, R⁷, R⁸, R⁹, R¹⁰, R¹¹, R¹² can be

### R═F or Cl or Br or I or NO₂ or COOR′ or R′ or CF₃ or COR′ or OR′ or NR′₂

R′=alkyl(C₁ to C₂₀) or H

The relevant materials used in the anodic electrode system comprise an anodic lithium insertion material and an n-type redox active compound dissolved in the electrolyte of the anodic compartment.

Preferred anodic lithium insertion materials used herein are: Doped or non-doped TiO₂, SnO₂, SnO, Li₄Ti₅O₁₂ nano- or sub-microparticles. The particle size ranges from 10 nm to 10 micrometer, preferably 10-500 nm.

Preferred n-type redox active compounds have the following structure:

### Transition Metal Complexes (see Above, Scheme 3),

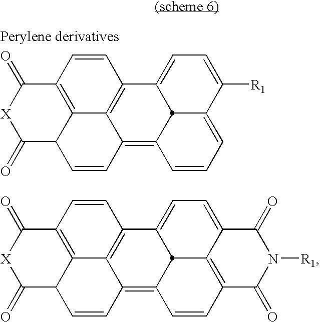

### X═O or NCH2R

### R1=H or C1 to C20

or

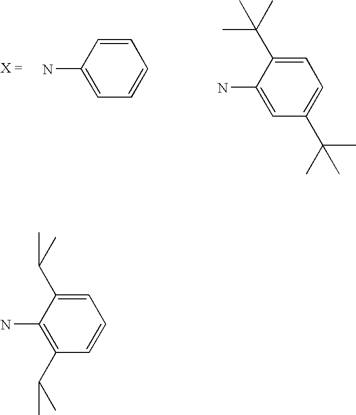

### R1=NHCH2R

R=alkyl(C₁ to C₂₀) or H

The separator used herein can be solid electrolyte-fast lithium ion conductor, such as Lithium Phosphorus Oxynitride (LiPON), 70Li₂S.30P₂S₅, etc. or ceramic nanofiltration membrane, which allows the transport of lithium ions through it, but prohibits the permeation of the redox active compounds.

In one embodiment of the invention, the rechargeable electrochemical cell comprises:
(a) A first electrode compartment comprising cathodic electrode, electrolyte with or without p-type redox active compound dissolved therein. The cathodic electrode comprises cathodic lithium insertion material, binder, conductive additives.
(b) A second electrode compartment comprising anodic electrode, electrolyte with or without n-type redox active compound dissolved therein. The anodic electrode comprises anodic lithium insertion material, binder, conductive additives.
(c) At least one of the electrode compartments with redox active compound dissolved therein.
(d) A separator intermediate the two electrode compartments.

In a preferred embodiment, the rechargeable electrochemical cell according to the invention comprises:
(a) A first electrode compartment comprising cathodic electrode, electrolyte with or without p-type redox active compound dissolved therein.
(b) A second counter electrode comprising binder, conductive additives, and anodic lithium insertion material such as carbon, TiO₂, Li₄Ti₅O₁₂, SnO₂, SnO, SnSb alloy, Si, etc.
(c) A separator intermediate the two electrode compartments.

In a particularly preferred embodiment of the rechargeable electrochemical cell of the present invention, the cathodic electrode comprising binder, conductive additives, and doped or non-doped LiMPO₄, wherein M=Fe, Mn, Co in first electrode compartment, having p-type redox active compound dissolved therein; and the second electrode comprising binder, conductive additives, and anodic lithium insertion material.

In this embodiment, the electronic conductivity of the cathodic lithium insertion materials is very poor, and the presence of p-type redox active compound makes the treated electrode system much more electrochemically addressable.

The invention is illustrated in the following EXAMPLES.

### EXAMPLE 1

LiFePO₄ powder with particle size distribution of 200˜700 nm was mixed with PVDF in weight ratio of 95:5. A 1.0 cm×1.0 cm electrode sheet comprising 10 μm thick same was used as working electrode, with lithium foil as counter and reference electrodes for electrochemical test. The three electrodes were separated to three compartments by glass frits and filled with EC+DMC (1:1)/1M LiPF₆ electrolyte. In the LiFePO₄ electrode compartment, 0.1M MPTZ was dissolved therein.

FIG. 3B shows the cyclic voltammograms (CV) of the electrode system. Because the reaction in FIG. 2B is turned on at around 3.5V (vs. Li+/Li), MPTZ is oxidized at current collector and diffuse to LiFePO₄, where the oxidized MPTZ is reduced by LiFePO₄ since the local equilibrium potential of MPTZ is slightly higher than that of LiFePO₄. Electrons and lithium ions are withdrawn from it. And the CV shows steady-state like curve. During inverse process, analogue process occurs. The limiting currents are 1.9 mA/cm² for charging and 0.7 mA/cm² for discharging. In comparison, LiFePO₄ electrode sheet without p-type redox active compound is almost inactive as shown in FIG. 3A.

### EXAMPLE 2

LiFePO₄ powder with particle size distribution of 200˜700 nm was mixed with PVDF and acetylene black in weight ratio of 95:5. A 1.0 cm×1.0 cm electrode sheet comprising 10 μm thick same was used as working electrode, with lithium foil as counter and reference electrodes for electrochemical test. The three electrodes were separated to three compartments by glass frits and filled with EC+DMC (1:1)/1M LiPF₆ electrolyte. In the LiFePO₄ electrode compartment, 0.032 M Os(mobpy)₃Cl₂ and Os(mbpy)₃Cl₂ was dissolved therein. The volume of electrolyte in cathodic compartment is 30 μl.

FIG. 3B shows the CV of the electrode system at different scan rates. The finite length diffusion of the compound within the electrode film renders the limiting current being independent of the scan rates. As the potential is higher than 3.55V (vs.Li+/Li), both Os complexes are oxidized at current collector. Charges (holes) are transported from the current collector to LiFePO₄ by the diffusion of the oxidized Os(mbpy)₃Cl₂. Since its potential is higher than that of LiFePO₄, the oxidized Os(mbpy)₃Cl₂ is reduced by LiFePO₄. Electrons and lithium ions will be withdrawn from it as illustrated in FIG. 2B. And it shows steady-state like curve. During inverse process, as the potential is lower than 3.3V, both complexes are reduced at current collector. Charges (electrons) are transported from the current collector to LiFePO₄ by the diffusion of the oxidized Os(mobpy)₃Cl₂. Since its potential is lower than that of LiFePO₄, the reduced Os(mobpy)₃Cl₂ is oxidized by LiFePO₄. Electrons and lithium ions will be injected into it.

FIG. 4 shows the voltage profiles of the cell at a constant current of 0.03 mA. The charging/discharging voltage plateaus show that the concept is working well.

### Part H: Polymer Wiring

It has been discovered that the presence of some redox active polymer compounds covered on active material forms an electrochemically addressable electrode system. As illustrated in FIG. 6, for a cathodic lithium insertion material and a p-type redox active polymer compound (S), upon positive polarization the p-type redox active compound will be oxidized at current corrector and charges (holes) will be transported from the current collector to the lithium insertion material by the diffusion of the oxidized p-type redox active compound (S+). As the redox potential of the p-type redox active compound is higher or matches closely the Fermi level of the lithium insertion material, S+ will be reduced by the lithium insertion material. Electrons and lithium ions will be withdrawn from it during battery charging. By contrast, during the discharging process, the oxidized species are reduced at current collector and charges (electrons) are transported from the current collector to the lithium insertion material by the diffusion of p-type redox active compound (S). Lithium ions and electrons are injected into the solid, as the redox potential of the p-type redox active compound is lower or matches closely the Fermi level of the lithium insertion material.

The cell is composed of two compartments, where the cathodic compartment comprises a cathodic lithium insertion material and p-type redox active polymer compound(s); the anodic compartment comprises an anodic lithium insertion material and n-type redox active polymer compound(s), which can also act as binder. These two compartments are separated by a separator. Compared to the whole electrode system, the redox active polymer do not occupy any extra volume of the whole electrode system. Hence with respect to prior art, the present invention allows reducing greatly the volume of the conductive additives resulting in a much improved energy storage density. The polymer redox material is not soluble in the working electrolyte so the use of a special separator as described in the European patent application 06 112 361.8 is not necessary.

According to the present invention, a redox active molecule is attached to the polymer backbone, either by covalent bonding or quternization. A suitable polymer may be selected from polyvinyl pyridine, polyvinyl imidazole, polyethylene oxide, polymethylmethacrylate, polyacrylonitrile, polypropylene, polystyrene, polybutadiene, polyethyleneglycol, polyvinylpyrrolidone, polyaniline, polypyrrole, polythiophene and their derivatives. Preferred polymer is polyvinyl pyridine.

A redox active centre may an organic compound or a metal complex having suitable redox potential as that of the battery material.

In preferred configuration the redox active metal complex or organic compound (D) is of the type given below,

D-π(Ral)_{q}- (1)

wherein π represents schematically the π system of the aforesaid substituent, Ral represents an aliphatic substituent with a saturated chain portion bound to the π system, and wherein q represents an integer, indicating that π may bear more than one substituent Ral.

The π system π may be an unsaturated chain of conjugated double or triple bonds of the type

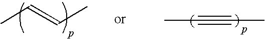

wherein p is an integer from 0 to 20.

or an aromatic group Rar of from 6 to 22 carbon atoms, or a combination thereof.
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1,

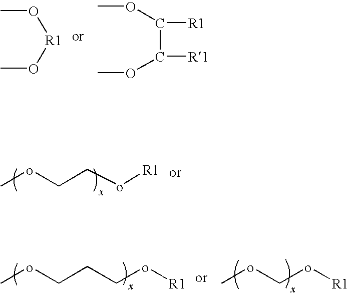

wherein R1, R′1 is an alkyl from 1 to 10 carbon atoms, x≧0, and 0<n<5.

According to a preferred embodiment, D is selected from benzol, naphtaline, indene, fluorene, phenantrene, anthracene, triphenylene, pyrene, pentalene, perylene, indene, azulene, heptalene, biphenylene, indacene, phenalene, acenaphtene, fluoranthene, and heterocyclyc compounds pyridine, pyrimidine, pyridazine, quinolizidine, quinoline, isoquinoline, quinoxaline, phtalazine, naphthyridine, quinazoline, cinnoline, pteridine, indolizine, indole, isoindole, carbazole, carboline, acridine, phenanthridine, 1,10-phenanthroline, thiophene, thianthrene, oxanthrene, and derivatives thereof, optionally be substituted.

According to a preferred embodiment, D is selected from structures of formula (1-11) given below:

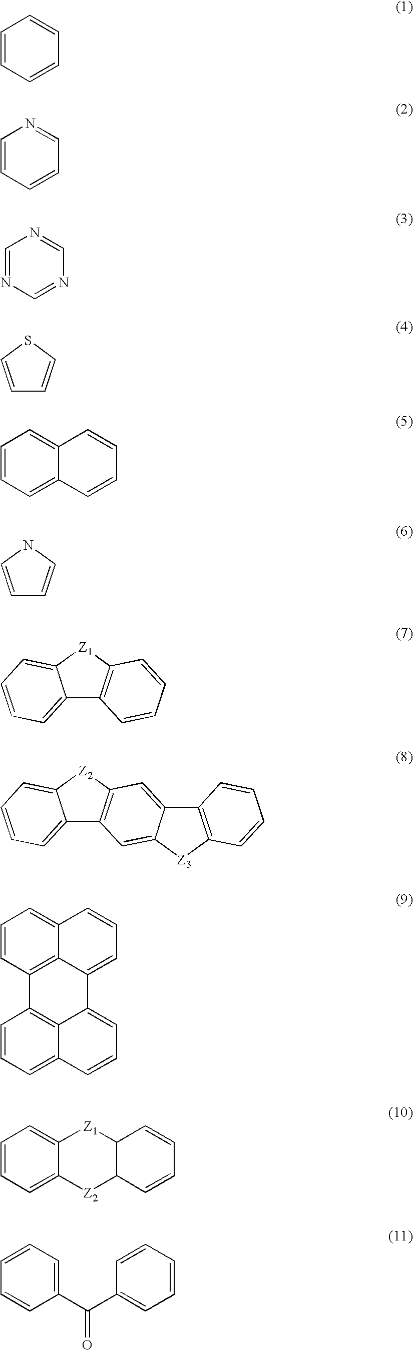

in which each of Z¹, Z² and Z³ is the same or different and is selected from the group consisting of O, S, SO, SO₂, NR¹, N⁺(R^{1′})(^{1″}), C(R²)(R³), Si(R^{2′})(R^{3′}) and P(O)(OR⁴), wherein R¹, R^{1′} and R^{1″} are the same or different and each is selected from the group consisting of hydrogen atoms, alkyl groups, haloalkyl groups, alkoxy groups, alkoxyalkyl groups, aryl groups, aryloxy groups, and aralkyl groups, which are substituted with at least one group of formula —N⁺(R⁵)₃ wherein each group R⁵ is the same or different and is selected from the group consisting of hydrogen atoms, alkyl groups and aryl groups, R², R³, R^{2′} and R^{3′} are the same or different and each is selected from the group consisting of hydrogen atoms, alkyl groups, haloalkyl groups, alkoxy groups, halogen atoms, nitro groups, cyano groups, alkoxyalkyl groups, aryl groups, aryloxy groups and aralkyl groups or R² and R³ together with the carbon atom to which they are attached represent a carbonyl group, and R⁴ is selected from the group consisting of hydrogen atoms, alkyl groups, haloalkyl groups, alkoxyalkyl groups, aryl groups, aryloxy groups and aralkyl groups.

Preferred embodiments of, structure (10) for D may be selected from structures (12) and (13) below:

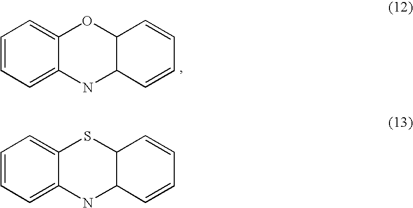

Alternatively a redox active centre may be a metal complex having suitable redox potential as that of the battery material.

These aims are achieved by using, as a ligand, an organic compound L1 having a formula selected from the group of formulae (14) to (27)

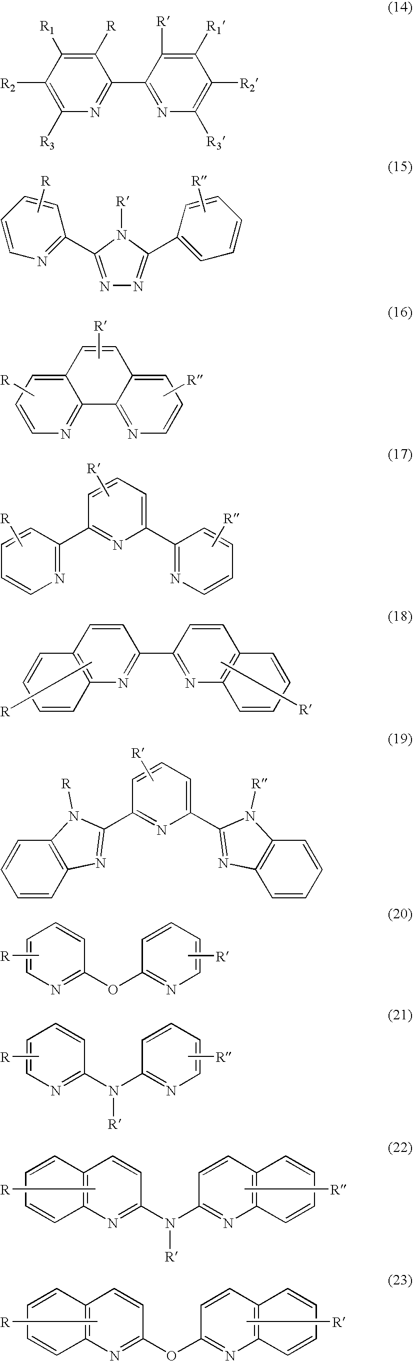

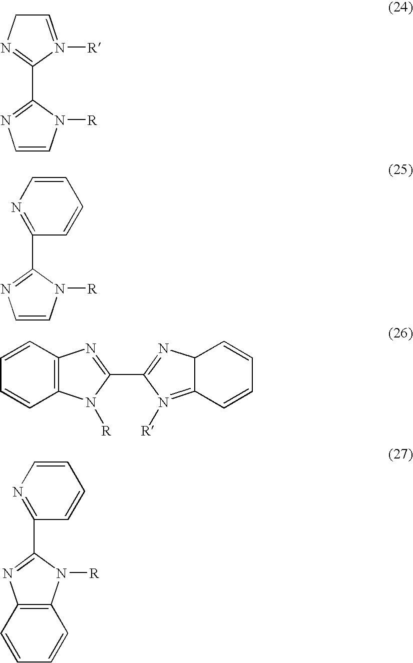

wherein at least one of substituents —R, —R₁, —R₂, —R₃,

—R′, —R₁′, —R₂′, —R₃′, —R″ comprises an additional π system located in conjugated relationship with the primary π system of the bidentate or respectively tridentate structure of formulae (14) to (27).

In preferred compounds L1, the said substituent is of the type

—R=π(Ral)_{q}

wherein π represents schematically the π system of the aforesaid substituent, Ral represents an aliphatic substituent with a saturated chain portion bound to the π system, and wherein q represents an integer, indicating that π may bear more than one substituent Ral.

The π system π may be an unsaturated chain of conjugated double or triple bonds of the type

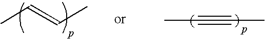

wherein p is an integer from 0 to 8.

or an aromatic group Rar of from 6 to 22 carbon atoms, or a combination thereof.

The presence of an aromatic group is preferred, since it is less sensitive to oxidation than a long chain of conjugated double or triple bonds.

Among suitable aromatic groups, there are monocyclic aryls like benzene and annulenes, oligocyclic aryls like biphenyle, naphthalene, biphenylene, azulene, phenanthrene, anthracene, tetracene, pentacene, or perylene. The cyclic structure of Rar may incorporate heteroatoms.

In metal complexes as redox active centers, the preferred ligands coordinated to the metal, according to the invention are organic compounds L1 having a formula selected from the group of formulae (14) to (27)

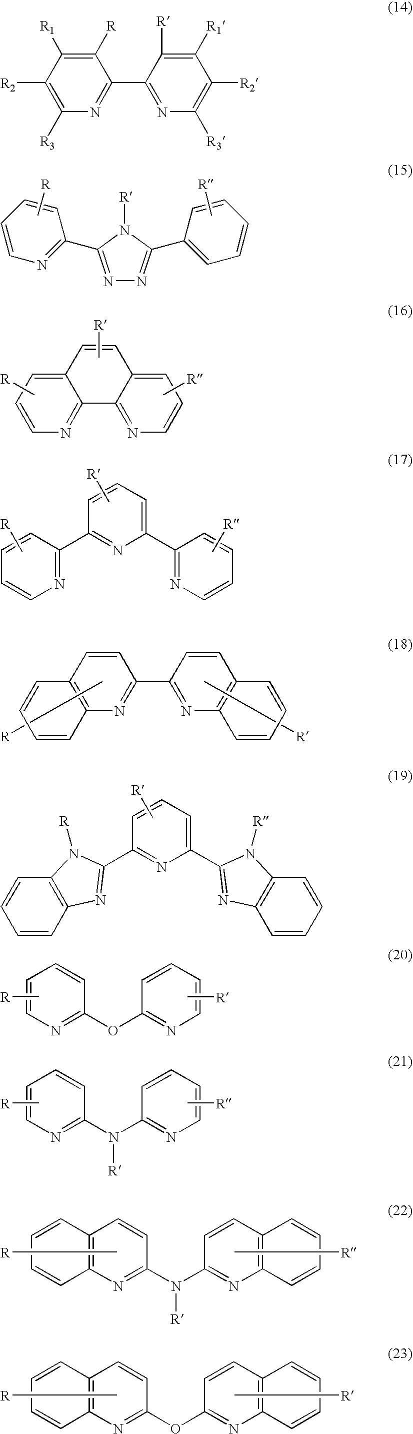

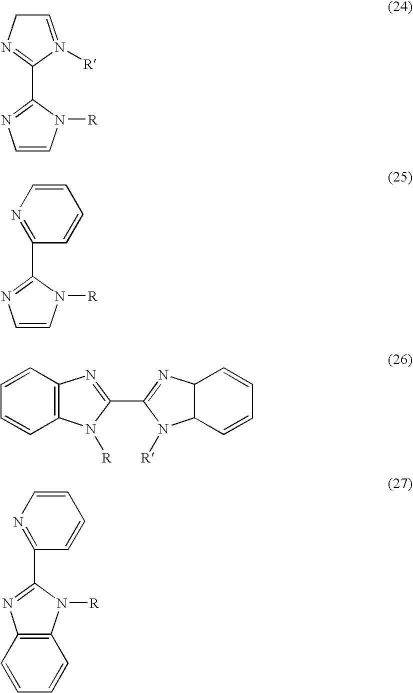

wherein at least one of the substituents —R, —R₁, —R₂, —R₃,

—R′, —R₁′, —R₂′, —R₃′, —R″ is of formula (2), (3) or (4)

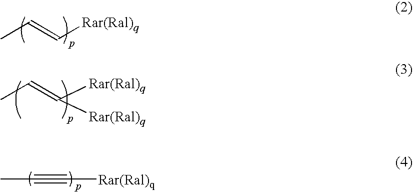

wherein p is an integer from 0 to 4,

wherein q is an integer from 0 to 4,

wherein Rar is a monocyclic or oligocyclic aryl from C6 to C22,

wherein -Ral is H, —R1, (—O—R1)ₙ, —N(R1)₂, —NHR1,

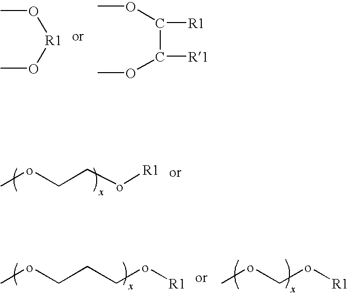

wherein R1, R′1 is an alkyl from 4 to 10 carbon atoms, x≧2 and 0<n<5 and

wherein the other one(s) of substituent(s) —R, —R₁, —R₂, —R₃, —R′, —R₁′, —R₂′, —R₃′, —R″ is (are) the same or a different substituents of formula (1), (2) or (3), or is (are) selected from —H, —OH, —R₂, —OR₂ or —N(R₂)₂, wherein R₂ is an alkyl of 1 to 20 carbon atoms.

The resulting compound is an organometallic complex of a metal Me selected from the group consisting of Ru, Os and Fe, comprising as a ligand a compound L and L1 as described herein before, said complex being of formula

MeL1L(Z)₂ (5)

if L and L1 are the same or different from a compound of formulas (15), (16), (18), (20), (21), (22) or (23), (24), (25), (26), (27), (28)

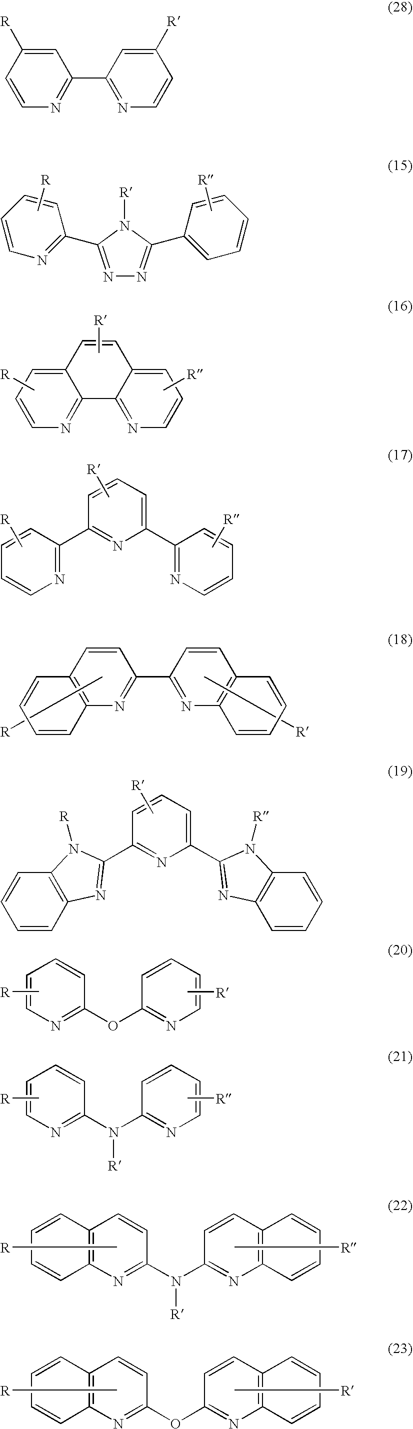

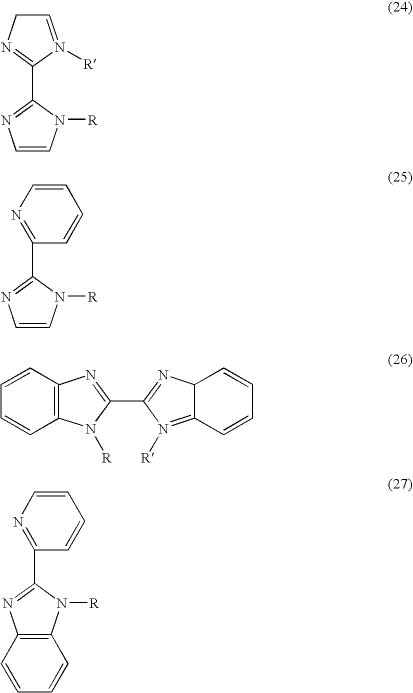

and of formula

MeL2LZ (6)

if L is from a compound of formula (15), (16), (18), (20), (21), (22), (23) or (24), (25), (26), (27), (28) and L2 is a compound of formula (17) or (19)

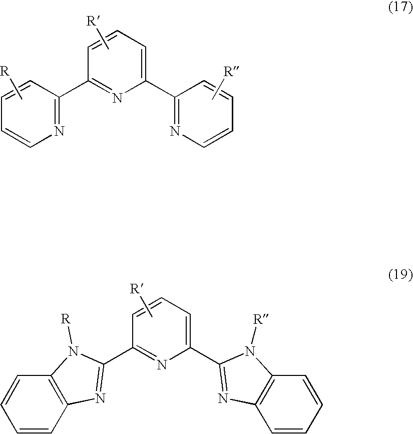

wherein Z is selected from the group consisting of H₂O, Cl, Br, CN, NCO, NCS and NCSe and

wherein in L at least one of substituents R, R′, R″ comprises a π system in conjugated relationship with the π system of the bidentate, respectively the tridentate structure of formulae (14) to (28),

and wherein the other one(s) of substituents R, R′, R″ is (are) the same or a different substituent including a π system, or is (are) selected from H, OH, R2, (OR2)ₙ, N(R2)₂, where R2 is an alkyl of 1-20 carbon atoms and 0<n<5.

and of formula

MeL1(L2)(L3) (7)

wherein L1, L2 and L3 are the same or different from a compound of formula (14), (15), (16), (18), (20), (21), (22), (23), (24), (25), (26), (27) or (28)

and of formula

Me(L1)(L2) (8)

wherein L1 and L2 may be same or different, and at least one of substituents R, R′, R″ comprises a π system in conjugated relationship with the π system of the tridentate structure of formulae (17) to (19),

and wherein the other one(s) of substituents R, R′, R″ is (are) the same or a different substituent including a 7 system, or is (are) selected from H, OH, R2, (OR2)ₙ, N(R2)₂, where R2 is an alkyl of 1-20 carbon atoms and 0<n<5.

### EXAMPLE 1

### Materials

LiFePO₄ was synthesized by a variant of solid state reaction ^{[}17] employing FeC₂O₄.2H₂O and LiH₂PO₄ as precursors. Their stoichiometric amounts were mixed and ground in a planetary ball-milling machine for 4 h. Then the powder was calcined in a tube furnace with flowing Ar—H₂ (92:8 v/v) at 600° C. for 24 h. After cooling down to room temperature, the sample was ground in agate mortar. The BET surface area of the powder was ca. 5 m²/g with an average particle size of 400 nm. X-ray diffraction confirmed the phase purity. The BET surface area of the powder was ca. 5 m²/g with an average particle size of 400 nm.

Synthesis of 10-(12′-bromododecyl)phenoxazine. Sodium hydride (55% dispersion in mineral oil; 119 mg, 4.97 mmol) was stirred in dry THF under argon atmosphere. Phenoxazine (500 mg, 2.73 mmol) was added to a stirred suspension of the sodium hydride in THF. The mixture was stirred to form phenoxazine N-sodium salt for 2 hours at 50° C. 1,12-dibromododecane (8962 mg, 27.3 mmol) was added to the solution and stirred vigorously for 24 hours at room temperature. The mixture was filtered and evaporated under reduced pressure. The excess 1,12-dibromododecane was recovered from the mixture by Kugelohr distillation (163° C., 0.1 mmHg). 10-(12′-bromododecyl)phenoxazine was distilled at 225° C. by Kugelohr distillation. The material was kept in inert atmosphere. The product was identified by ¹H NMR spectrum. ¹H NMR (400 MHz; CDCl₃); δ (ppm); 6.80 (2H, Ar—H), 6.67 (4H, Ar—H), 6.48 (2H, Ar—H), 3.49 (2H, t), 3.44 (2H, t), 1.87 (2H, m), 1.67 (2H, m), 1.42 (16H, m).

### Synthetic Route:

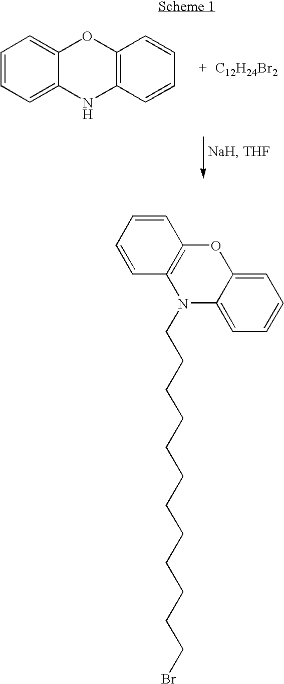

Poly(4-(-(10-(12′-dodecyl phenoxazine)pyridinium)-co-4-vinylpyridine). To a solution of poly(4-vinylpyridine) (number average molecular weight; 160,000) (173 mg) in 15 ml DMF was added LiTFSI (260 mg) and 10-(12′-bromododecyl)phenoxazine (111 mg, 0.26 mmoles). The solution was mechanically stirred at 50° C. for 36 h. The solution was cooled to room temperature and then diethyl ether was added slowly to obtain a precipitate of Poly(4-(-(10-(12′-bromododecyl phenoxazine)pyridinium)-co-4-vinylpyridine). The solid was collected by a vacuum filtration and dried under vacuum at 35° C. for 8 hrs. This redox polymer is insoluble in common organic solvents hampering the characterization of this material. The molar ratio of pyridine to phenoxazine was 1/6; the polymer is further abbreviated PPV-POA (1/6).

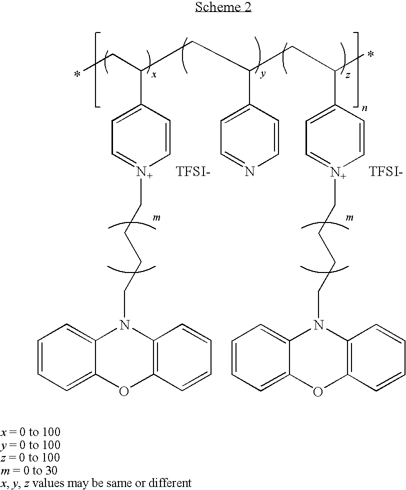

### Electrochemical Methods

The polymer PVP-POA(1/6) was stirred with γ-butyrolactone for several hours until a viscous slurry was obtained. This slurry was further mixed with LiFePO₄ powder while the proportion of PVP-POA(1/6) in the solid mixture with LiFePO₄ was 10 wt %. This slurry was stirred again overnight. The mixing and homogenization was sometimes also promoted by sonication in ultrasound bath. The resulting homogeneous slurry was then doctor-bladed onto F-doped conducting glass (FTO) and dried at 100° C. The typical film mass was ca. 1 mg/cm². Blank electrodes from pure PVP-POA(1/6) were prepared in the same way for reference experiments. In this case, the typical film mass was 0.1 to 0.2 mg/cm².

Electrochemical experiments employed an Autolab PGSTAT 30 potentiostat. The electrolyte was 1 M LiPF₆ in ethylene carbonate (EC)/dimethyl carbonate (DMC) (1:1, v:v). The reference and counter electrodes were from L1-metal.

### Results and Discussion

FIG. 5 (left chart) shows the cyclic voltammograms of pure PVP-POA(1/6) film. Independent of the scan rate, the integrated charge for anodic/cathodic process was between 4 to 5.2 mC, which gives ca. 28-37 C/g for the electrode in FIG. 5. This is roughly half of the expected specific charge capacity of PVP-POA(1/6) assuming the molecular formula as in Scheme 2. The redox couple with formal potential at ca. 3.5 V vs. Li/Li⁺ is obviously assignable to phenoxazine, but the origin of the second redox couple at ca. 3.75 V vs. Li/Li⁺ is not clear. We should note that the PVP-POA(1/6) film reversibly switches to red color in the oxidized state.

FIG. 5 (right chart) shows the cyclic voltammograms of LiFePO₄/PVP-POA(1/6) composite film. At faster scan rates, the electrode exhibits characteristic plateau of anodic currents, which is a signature of molecular wiring ^{[15]} or redox targeting ^{[16]}. In the first case, the redox species is adsorbed on the LiFePO₄ surface ^{[15]}, whereas in the second case, the charge is transported by molecules dissolved in the electrolyte solution ^{[16]}.

Obviously, the phenoxazine, which is covalently bonded to a polymer backbone, acts as a mediator, providing holes to interfacial charge transfer of LiFePO₄. The long (C₁₂) aliphatic chain grants sufficient swinging flexibility to the redox mediator, so that it can reach the olivine surface. We suggest calling this effect as “polymer wiring”. Its advantage over molecular wiring ^{[15]} consists in the fact, that the amount of redox material can be easily increased above the monolayer coverage. This would allow running larger currents, as the process is not limited by the speed of cross-surface hole percolation. The polymer wiring thus resembles the redox targeting ^{[16]}. However, the electrochemical cell employing polymer wiring does not require any molecular separator between the cathode and anode, which would prevent undesired transport of the redox-targeting molecule to the other electrode ^{[16]}. Hence, the polymer wiring seems to be the optimum strategy for enhancement of the electrochemical activity of virtually insulating materials like LiFePO₄. It combines the advantages of both approaches: (i) fixed redox species near the LiFePO₄ surface and (ii) larger amount of available redox species for wiring. The latter fact is also beneficial for the electrode stability, as the system is less sensitive to imperfections in the adsorbed monolayer of redox relay ^{[15]}.

At high scan rates, such as 50 mV/s, the polymer wiring is, however, not fast enough for charging of LiFePO₄ to a significant capacity. For the electrode in FIG. 6, the polymer wiring provides only 1.5 C/g of anodic charge at these conditions. This charge is actually smaller than that, which would correspond to a pure PVP-POA(1/6) polymer in the mixture. This is demonstrated by the blue curve in FIG. 6, where the cyclic voltammogram of pure PVP-POA(1/6) is shown, while the voltammograms for pure polymer was scaled considering the actual amount of polymer in the composite.

However, this charge balance changes in favor for charging of LiFePO₄ at slower scan rates. FIG. 7 evidences that the LiFePO₄ can be charged via the polymer by charges exceeding significantly the intrinsic charge capacity of the pure polymer present in the composite. For instance, at 0.1 mV/s, the electrode shown in FIG. 7 delivered 22 mAh/g of anodic charge.

### REFERENCE LIST POLYMER WIRING

[1] A. K. Padhi, K. S, Nanjundasawamy, J. B. Goodenough, J. Electrochem. Soc. 1997, 144, 1188-1194.
[2] C. Delacourt, L. Laffont, R. Bouchet, C. Wurm, J. B. Leriche, M. Mocrette, J. M. Tarascon, C. Masquelier, J. Electrochem. Soc. 2005, 153, A913-A921.
[3] P. S. Herle, B. Ellis, N. Coombs, L. F. Nazar, Nature Mat. 2004, 3, 147-152.
[4] M. Yonemura, A. Yamada, Y. Takei, N. Sonoyama, R. Kanno, J. Electrochem. Soc. 2004, 151, A1352-A1356.
[5] F. Zhou, K. Kang, T. Maxisch, G. Ceder, D. Morgan, Solid State Comm. 2004, 132, 181-186.
[6] B. Ellis, L. K. Perry, D. H. Ryan, L. F. Nazar, J. Am. Chem. Soc. 2006, 128.
[7] R. Dominko, M. Bele, M. Gaberseck, M. Remskar, D. Hanzel, J. M. Goupil, S. Pejovnik, J. Jamnik, J. Power Sources 2006, 153, 274-280.
[8] T. Nakamura, Y. Miwa, M. Tabuchi, Y. Yamada, J. Electrochem. Soc. 2006, 153, A1108-A1114.
[9] J. Ma, Z. Qin, J. Power Sources 2005, 148, 66-71.
[10] N. H. Kwon, T. Drezen, I. Exnar, I. Teerlinck, M. Isono, M. Grätzel, Electrochem. Solid State Lett. 2006, 9, A277-A280.
[11] A. Yamada, M. Hosoya, S. C. Chung, Y. Kudo, K. Hinokuma, K. Y. Liu, Y. Nishi, J. Power Sources 2003, 119-121, 232-238.
[12] G. Li, H. Azuma, M. Tohda, Electrochem. Solid State Lett. 2002, 5, A135-A137.
[13] C. Delacourt, P. Poizot, M. Morcrette, J. M. Tarascon, C. Masquelier, Chem. Mater. 2004, 16, 93-99.
[14] S. Y. Chung, J. T. Bloking, Y. M. Chiang, Nature Mat. 2002, 1, 123-128.
[15] Q. Wang, N. Evans, S. M. Zekeeruddin, I. Exnar, M. Grätzel, Nature Mat. 2006.
Q. Wang, S. M. Zakeeruddin, D. Wang, I. Exnar, M. Grätzel, Angew. Chem. 2006.
D. Wang, H. Li, Z. Wang, X. Wu, Y. Sun, X. Huang, L. Chen, J. Solid State Chem. 2004, 177, 4582-4587.

### Part III: Nanotube Wiring

It has been discovered that some amphiphilic redox active molecules interact to SWCNT can further anchor with the surface of electrode active material such as LiFePO₄ (olivine). The assembly of redox molecule and SWCNT thus covers the surface of the active material, forming an electrochemically addressable electrode system. For cathodic lithium insertion material upon positive polarization the donor redox active compound (D) will be oxidized at current corrector and charges (holes) will be transported from the current collector to the lithium insertion material by the oxidized form of the redox active compound (D⁺). As the redox potential of the redox active compound is higher or matches closely the Fermi level of the lithium insertion material, D⁺ will be reduced by the lithium insertion material. Electrons and lithium ions will be withdrawn from it during battery charging. By contrast, during the discharging process, the oxidized species are reduced at current collector and charges (electrons) are transported from the current collector to the lithium insertion material by the redox active compound (D). Lithium ions and electrons are injected into the solid, as the redox potential of the redox active compound is lower or matches closely the Fermi level of the lithium insertion material.

The cell is composed of two compartments, where the cathodic compartment comprises a cathodic lithium insertion material and redox active compound(s); the anodic compartment comprises an anodic lithium insertion material and redox active compound(s). These two compartments are separated by a separator. Compared to the whole electrode system, the redox active adsorbate does not occupy any significant extra volume of the whole electrode system. Hence with respect to prior art, the present invention allows reducing greatly the volume of the conductive additives resulting in a much improved energy storage density. The redox adsorbate is not soluble in the working electrolyte so the use of a special separator as described in the European patent application 06 112 361.8 is not necessary.

According to the present invention, a redox active molecule is attached to the SWCNT backbone by non-covalent bonding. A redox active centre (D) may be an organic compound or a metal complex having suitable redox potential as that of the battery material. In preferred configuration the redox active metal complex or organic compound (D) is localized between the SWCNT surface and the surface of electrode active material.

SWCNT-D-[M] (1)

Wherein [M] represents schematically the electrode material

### DEFINITIONS

As used herein, the term “donor-type redox active compound” refers to those compounds that are present in the cathodic compartment of the cell, and act as molecular relay transporting charges between current collector and cathodic lithium insertion material upon charging/discharging. On the other hand, the term “acceptor-type redox active compound” refers to the molecules that present in the anodic compartment of the cell, and act as molecular relay transporting charges between current collector and anodic lithium insertion material upon charging/discharging.

A redox active centre may be an organic compound or a metal complex having suitable redox potential as that of the lithium insertion material.

In preferred configuration the redox active metal complex or organic compound (D) is of the type given below,

D-π(Ral)_{q}

wherein π represents schematically the π system of the aforesaid substituent, Ral represents an aliphatic substituent with a saturated chain portion bound to the π system, and wherein q represents an integer, indicating that π may bear more than one substituent Ral.

The π system π may be an unsaturated chain of conjugated double or triple bonds of the type

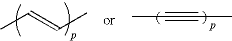

wherein p is an integer from 0 to 20.

or an aromatic group Rar of from 6 to 22 carbon atoms, or a combination thereof.
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1,

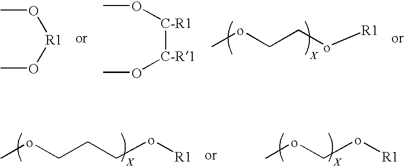

wherein R1, R′1 is an alkyl from 1 to 10 carbon atoms, x≧0, and 0<n<5.

According to a preferred embodiment, D is selected from benzol, naphtaline, indene, fluorene, phenantrene, anthracene, triphenylene, pyrene, pentalene, perylene, indene, azulene, heptalene, biphenylene, indacene, phenalene, acenaphtene, fluoranthene, and heterocyclyc compounds pyridine, pyrimidine, pyridazine, quinolizidine, quinoline, isoquinoline, quinoxaline, phtalazine, naphthyridine, quinazoline, cinnoline, pteridine, indolizine, indole, isoindole, carbazole, carboline, acridine, phenanthridine, 1,10-phenanthroline, thiophene, thianthrene, oxanthrene, and derivatives thereof, optionally be substituted.

According to a preferred embodiment, D is selected from structures of formula (1-11) given below:

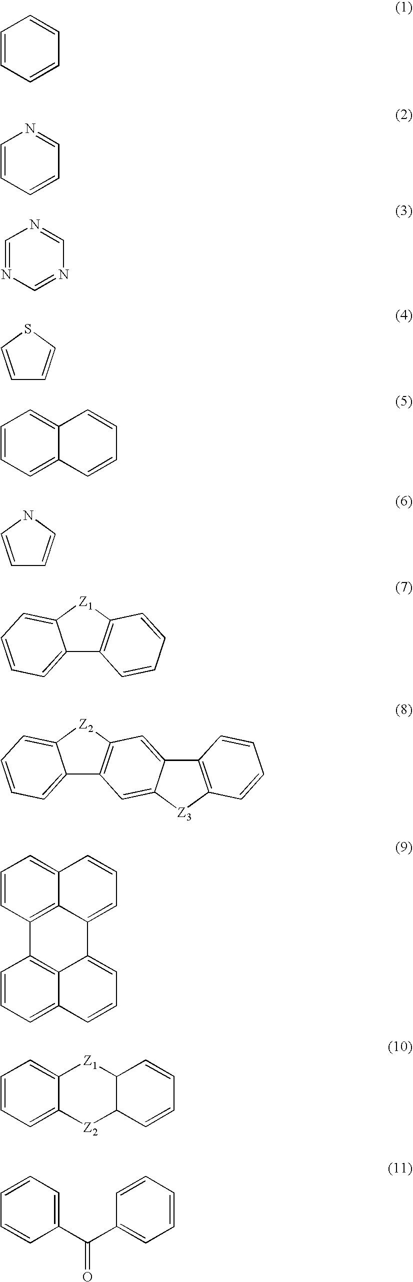

in which each of Z¹, Z² and Z³ is the same or different and is selected from the group consisting of O, S, SO, SO₂, NR¹, N⁺(R^{1′})(^{1″}), C(R²)(R³), Si(R^{2′})(R^{3′}) and P(O)(OR⁴), wherein R¹, R^{1′} and R^{1″} are the same or different and each is selected from the group consisting of hydrogen atoms, alkyl groups, haloalkyl groups, alkoxy groups, alkoxyalkyl groups, aryl groups, aryloxy groups, and aralkyl groups, which are substituted with at least one group of formula —N⁺(R⁵)₃ wherein each group R⁵ is the same or different and is selected from the group consisting of hydrogen atoms, alkyl groups and aryl groups, R², R³, R^{2′} and R^{3′} are the same or different and each is selected from the group consisting of hydrogen atoms, alkyl groups, haloalkyl groups, alkoxy groups, halogen atoms, nitro groups, cyano groups, alkoxyalkyl groups, aryl groups, aryloxy groups and aralkyl groups or R² and R³ together with the carbon atom to which they are attached represent a carbonyl group, and R⁴ is selected from the group consisting of hydrogen atoms, alkyl groups, haloalkyl groups, alkoxyalkyl groups, aryl groups, aryloxy groups and aralkyl groups.

Preferred embodiments of, structure (10) for D may be selected from structures (12) and (13) below:

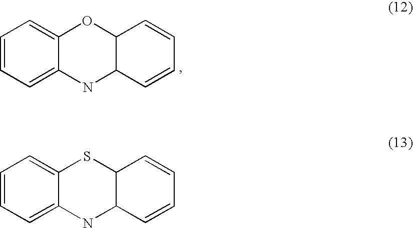

Alternatively a redox active centre may be a metal complex having suitable redox potential as that of the lithium insertion material.

These aims are achieved by using, as a ligand, an organic compound L1 having a formula selected from the group of formulae (14) to (27)

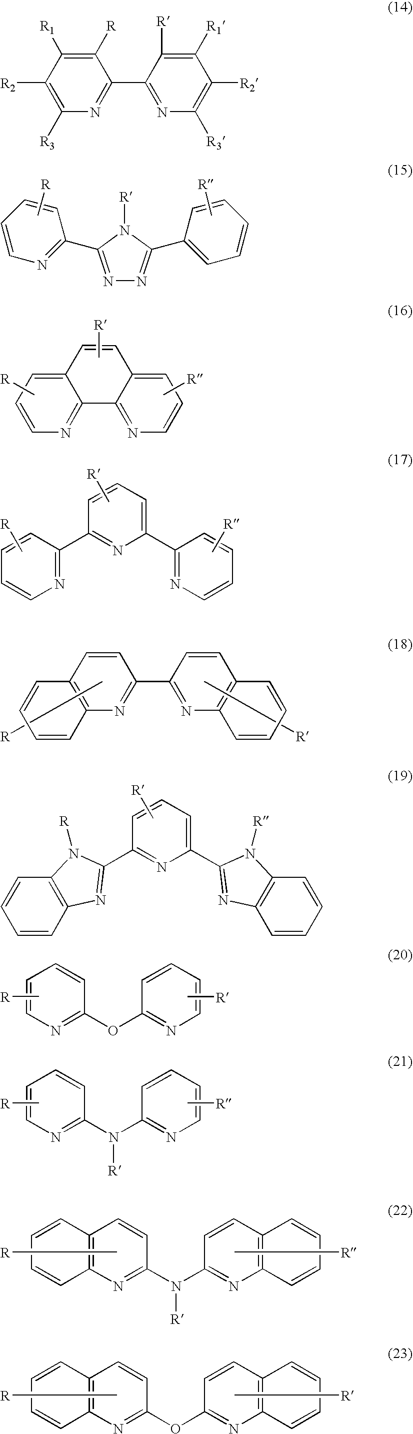

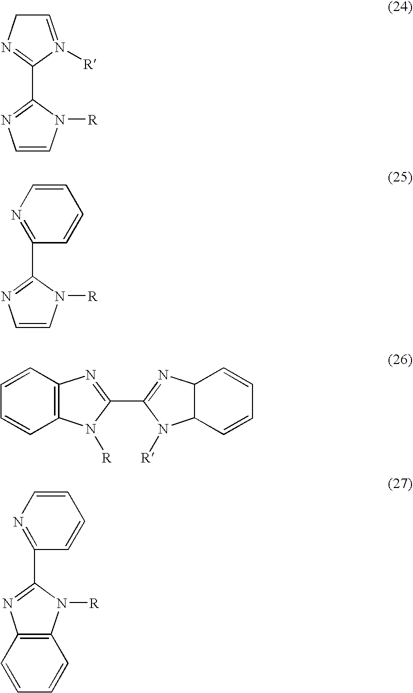

wherein at least one of substituents —R, —R₁, —R₂, —R₃,

—R′, —R₁′, —R₂′, —R₃′, —R″ comprises an additional π system located in conjugated relationship with the primary π system of the bidentate or respectively tridentate structure of formulae (14) to (27).

In preferred compounds L1, the said substituent is of the type

—R=π(Ral)_{q}

wherein π represents schematically the π system of the aforesaid substituent, Ral represents an aliphatic substituent with a saturated chain portion bound to the π system, and wherein q represents an integer, indicating that π may bear more than one substituent Ral.

The π system π may be an unsaturated chain of conjugated double or triple bonds of the type

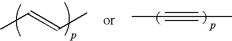

wherein p is an integer from 0 to 8.

or an aromatic group Rar of from 6 to 22 carbon atoms, or a combination thereof.

The presence of an aromatic group is preferred, since it is less sensitive to oxidation than a long chain of conjugated double or triple bonds.

Among suitable aromatic groups, there are monocyclic aryls like benzene and annulenes, oligocyclic aryls like biphenyle, naphthalene, biphenylene, azulene, phenanthrene, anthracene, tetracene, pentacene, perylene or pyrene. The cyclic structure of Rar may incorporate heteroatoms.

In metal complexes as redox active centers, the preferred ligands coordinated to the metal, according to the invention are organic compounds L1 having a formula selected from the group of formulae (14) to (27)

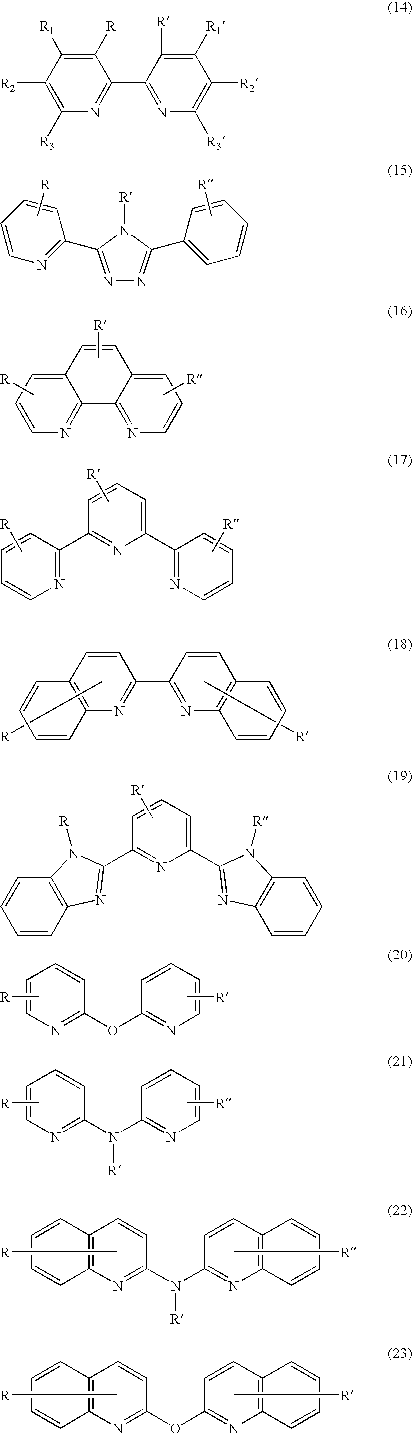

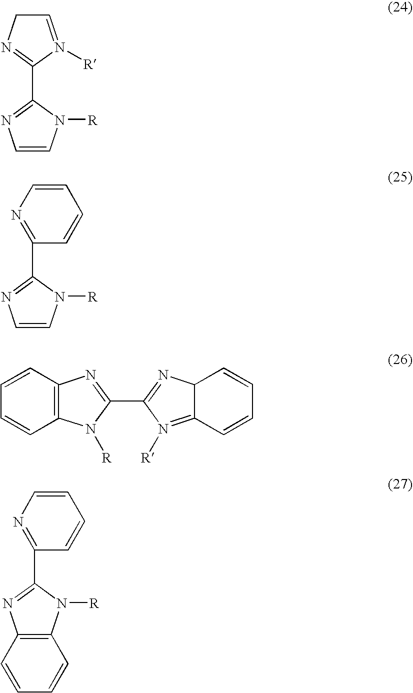

wherein at least one of the substituents —R, —R₁, —R₂, —R₃,

—R′, —R₁′, —R₂′, —R₃′, —R″ is of formula (1), (2) or (3)

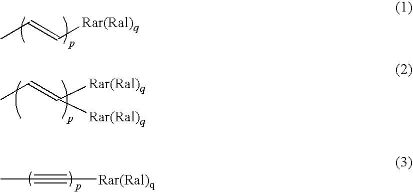

wherein p is an integer from 0 to 4,

wherein q is an integer from 0 to 4,

wherein Rar is a monocyclic or oligocyclic aryl from C6 to C22,

wherein -Ral is H, —R1, (—O—R1)ₙ, —N(R1)₂, —NHR1,

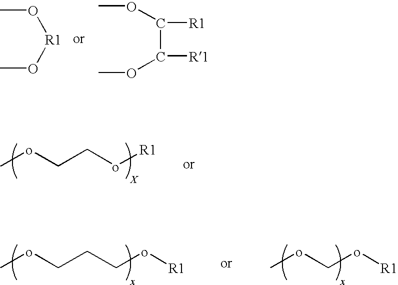

wherein R1, R′1 is an alkyl from 4 to 10 carbon atoms, x≧2 and 0<n<5 and

wherein the other one(s) of substituent(s) —R, —R₁, —R₂, —R₃, —R′, —R₁′, —R₂′, —R₃′, —R″ is (are) the same or a different substituents of formula (1), (2) or (3), or is (are) selected from —H, —OH, —R₂, —OR₂ or —N(R₂)₂, wherein R₂ is an alkyl of 1 to 20 carbon atoms.

The resulting compound is an organometallic complex of a metal Me selected from the group consisting of Ru, Os and Fe, comprising as a ligand a compound L and L1 as described herein before, said complex being of formula

MeL1L(Z)₂ (I)

if L and L1 are the same or different from a compound of formulas (15), (16), (18), (20), (21), (22) or (23), (24), (25), (26), (27), (28)

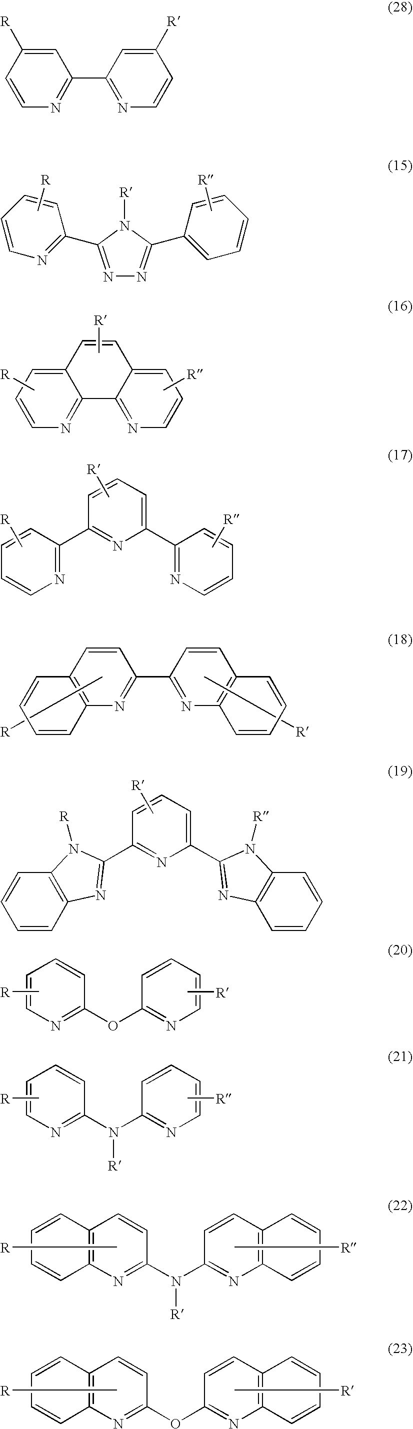

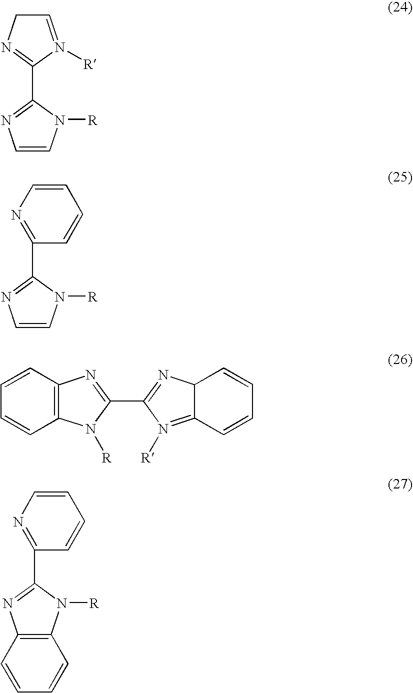

and of formula

MeL2LZ (II)

if L is from a compound of formula (15), (16), (18), (20), (21), (22), (23) or (24), (25), (26), (27), (28) and L2 is a compound of formula (17) or (19)

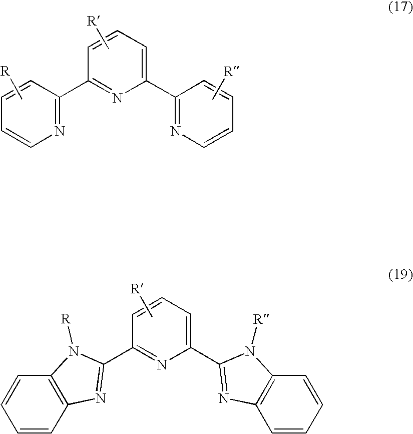

wherein Z is selected from the group consisting of H₂O, Cl, Br, CN, NCO, NCS and NCSe and

wherein in L at least one of substituents R, R′, R″ comprises a π system in conjugated relationship with the π system of the bidentate, respectively the tridentate structure of formulae (14) to (28),

and wherein the other one(s) of substituents R, R′, R″ is (are) the same or a different substituent including a π system, or is (are) selected from H, OH, R2, (OR2)ₙ, N(R2)₂, where R2 is an alkyl of 1-20 carbon atoms and 0<n<5.

and of formula

MeL1(L2)₂ (3)

wherein L1 and L2 are the same or different from a compound of formula (14), (15), (16), (18), (20), (21), (22), (23), (24), (25), (26), (27) or (28)

and of formula

Me(L2)(L2) (4)

wherein L2 may be same or different, in L2 at least one of substituents R, R′, R″ comprises a π system in conjugated relationship with the π system of the tridentate structure of formulae (17) and (19),

and wherein the other one(s) of substituents R, R′, R″ is (are) the same or a different substituent including a π system, or is (are) selected from H, OH, R2, (OR2)ₙ, N(R2)₂, where R2 is an alkyl of 1-20 carbon atoms and 0<n<5.

### EXAMPLE 1

### Materials

LiFePO₄ was synthesized by a variant of solid state reaction ^{[15]} employing FeC₂O₄.2H₂O and LiH₂PO₄ as precursors. Their stoichiometric amounts were mixed and ground in a planetary ball-milling machine for 4 h. Then the powder was calcined in a tube furnace with flowing Ar—H₂ (92:8 v/v) at 600° C. for 24 h. After cooling down to room temperature, the sample was ground in agate mortar. The BET surface area of the powder was ca. 5 m²/g with an average particle size of 400 nm. X-ray diffraction confirmed the phase purity. The Ru-bipyridine complex, NaRu(4-carboxylic acid-4′-carboxylate(4,4′-dionyl-2,2′bipyridine)(NCS)₂, coded as Z-907Na was synthesized as described elsewhere ^{[16]}. Single walled carbon nanotubes were grown by catalytic laser ablation method. The average diameter of tubes was determined by Raman and Vis-NIR spectroscopy to be ca. 1.3-1.4 nm. Other chemicals were from commercial sources and were used as received.

SWCNT were dispersed with solutions of surfactants (either pyrene butanoic acid in dimethylformamide (DMF) or Z-907Na in acetonitrile+tert-butanol (1:1) (AN/t-BuOH) by sonication. The optimized synthetic protocol for Z-907Na was as follows: 9 mg of SWCNT was sonicated for 2 hours with 10 mL of 6·10⁻⁴ M Z-907Na in acetonitrile+t-butanol (1:1). The resulting black-brown solution was centrifuged at 5000 rpm for 1 hour, while ca. 4 mg of undissolved carbon remained as a sediment. This working solution (abbreviated further as Z-907Na/SWCNT) was stable for at least weeks at room temperature without precipitation. Hence, the solution contained ca. 5 mg of dispersed SWCNT (417 μmol) and 6 μmol of Z-907Na (molar ratio C/Z-907Na≈70). The olivine LiFePO₄ (200 mg) was mixed with several portions (0.5-0.7 mL) of this working solution. At the initial stages, the supernatant turned to colorless within several seconds after mixing. After each addition of the Z-907Na/SWCNT solution, the slurry was centrifuged, supernatant separated and a next portion of the solution was added. This procedure was repeated until the supernatant did not decolorize. The total amount of applied solution was 1.5 mL. Finally the powder was washed with AN/t-BuOH and dried at room temperature. The same synthetic protocol was also adopted also for surface derivatization of LiFePO₄ with pyrenebutanoic acid/SWCNT.

Electrodes were prepared by mixing the powder of surface derivatized LiFePO₄ with 5 wt % of polyvinylidene fluoride (PVDF) dissolved in N-methyl-2-pyrolidone. The resulting homogeneous slurry was then doctor-bladed onto F-doped conducting glass (FTO) and dried at 10° C. overnight. Alternatively the slurry was coated on alumina current collector and dried at 100° C. overnight. The typical film mass was 1.5-2 mg/cm². Blank electrodes from pure LiFePO₄ were prepared in the same way for reference experiments. A second reference material was a carbon-coated LiFePO₄ (Nanomyte BE-20 from NEI Corporation, USA).

The electrode was assembled in the electrochemical cell with Li reference and counter electrodes or alternatively in the Swagelok cell with Li negative electrode.

### Methods

Vis-NIR spectra were measured at Varian Cary 5 spectrometer in 2 mm glass optical cells. The measurement was carried out in transmission mode with integrating sphere. Electrochemical experiments employed an Autolab PGSTAT 30 potentiostat. The electrolyte was 1 M LiPF₆ in ethylene carbonate (EC)/dimethyl carbonate (DMC) (1:1, v:v). The reference and counter electrodes were from Li-metal.

### Results and Discussion

FIG. 8 shows the Vis-NIR spectra of 6×10⁻⁴ M solution of Z-907Na complex and the working solution Z-907Na/SWCNT. In the latter case, we detected the characteristic features of carbon nanotubes. Semiconducting SWCNT are characterized by optical transitions between van Hove singularities at ca. 0.7 eV and 1.3 eV for the first and second pair of singularities, respectively. Metallic tubes manifest themselves by a transition at 1.8-1.9 eV, which corresponds to the first pair of Van Hove singularities. The main peak of Z-907Na occurs at ca. 2.35 eV, and it is blue shifted by ca. 50 meV in the SWCNT-containing solution (FIG. 8). Obviously, the Z-907Na complex acts as an efficient surfactant for SWCNT, due to the presence of hydrophobic aliphatic C₉ chains (Scheme 1), which interact with the carbon tube surface. There are many other molecules reported for solubilization of SWCNT, the most popular being sodium dodecyl sulfate ^{[17]}, but, to the best of our knowledge, the solubilization of SWCNT by Ru-bipyridine complexes is here demonstrated for the first time.

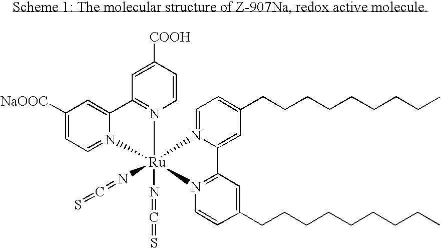

FIG. 9 (left chart) shows the cyclic voltammogram of a pure (carbon free) LiFePO₄ (bonded with 5% PVDF), which was treated by dip-coating into 6×10⁻⁴ mol/L solution of Z-907Na for 3 hours, rinsed with AN/t-BuOH and dried in vacuum at room temperature. The right chart plots analogous data for pure LiFePO₄ electrode, which was treated with Z-907Na/SWCNT solution in the same way. We see a plateau anodic current, which indicates the so-called “molecular wiring” of LiFePO₄^{[18]}. The Z-907Na complex (as in Scheme 1, can transport electronic charge via surface percolation in adsorbed monolayer even on insulating surfaces like Al₂O₃ ^{[19]}. Here, the NCS groups act as mediators for the surface-confined hole percolation, and the bipyridine ligands transport electrons. The hole diffusion coefficient within adsorbed Z-907Na was of the order of 10⁻⁹ cm²/s above the charge percolation threshold, ca. 50% of surface coverage ^{[19]}.

The effect of molecular wiring was recently applied to the LiFePO₄ electrode material, which can be wired by 4-(bis(4-methoxyphenyl)amino)benzylphosphonic acid ^{[20]}. In this case, the cross-surface hole percolation was followed by interfacial charging and discharging of LiFePO₄ with Li⁺ ions ^{[20]}. Our data confirm that the hole-transport wiring is possible also with the Z-907Na complex, while a similar anodic current (exceeding 0.2 mA/cm²) can be wired to the LiFePO₄ electrode at 0.1 V/s. The formal redox potential of Z-907Na adsorbed on inert TiO₂ surface was about 3.5 V vs. Li/Li^{+ [19,21}], which is just sufficient for the anodic wiring of LiFePO₄ (redox potential 3.45 V vs. Li/Li⁺) but not for cathodic wiring ^{[20]}. Our data on FIG. 9 also confirm that the COOH/COONa are suitable anchoring groups for LiFePO₄, similar to the phosphonic acid anchoring group employed previously ^{[20]}. The total anodic charge was between 2 to 4 mC (0.4 to 0.7 mAh/g) for the electrode in FIG. 9 (left chart) at the given scan rates. This charge was not much larger at slower scanning and moreover, the electrode was unstable during repeated cycling at slower scan rates. The molecular wiring via adsorbed Z-907Na is sensitive to imperfections in the surface layer, which hamper the hole percolation.

FIG. 9 (right chart) shows a variant of the previous experiment, where the LiFePO₄ film was treated by dip-coating into Z-907Na/SWCNT solution. Surprisingly, the anodic current is now considerably smaller, which may be due to poor accessibility of the pores in the pre-deposited LiFePO₄ layer for SWCNT. As the carbon tubes are typically 1-10 μm long, they cannot easily interpenetrate the compact porous solid. Hence, the Z-907Na/SWCNT assemblies reside prevailingly on top of the LiFePO₄ layer. We may assume that either some free complex (Z-907Na) may still be present in our working solution Z-907Na/SWCNT or may be partly released from the SWCNT upon interaction with the LiFePO₄ surface. This causes poor surface coverage and attenuated molecular wiring in this case.

However, this situation changes dramatically, if the surface derivatization is carried out with the starting LiFePO₄ powder instead of the doctor-bladed porous film. FIG. 10 (left chart) shows cyclic voltammogram of this electrode compared to the voltammograms of an electrode, which was fabricated in the same way, but instead of using Z-907Na complex as a surfactant, the SWCNT were solubilized by pyrene butanoic acid. Obviously, this electrode shows practically no activity, indicating that the sole carbon nanotubes do not promote the charging/discharging of LiFePO₄. Also the electrode from carbon-coated LiFePO₄ (Nanomyte BE-20, NEI) shows much smaller activity compared to our Z-907Na/SWCNT electrode at the same conditions. A comparative experiment with Z-907Na/SWCNT treated LiMnPO₄ powder also showed practically no electrochemical activity (data not shown). The charging/discharging of LiFePO₄ via the surface attached Z-907Na/SWCNT assemblies was reasonably reversible, providing at 0.1 mV/s scan rate the specific capacity of ca. 41 mAh/h for anodic process and 40 mAh/g for cathodic process (see data on FIG. 10). The electrode was also quite stable, showing no obvious capacity fading in repeated voltammetric scans.

The exceptional properties of our Z-907Na/SWCNT electrode are further demonstrated by galvanostatic charging/discharging cycle. FIG. 10 (right chart) demonstrates that the Z-907Na/SWCNT electrode delivered at the charge rate C/5 and cut-off potentials 4 and 2.7 V vs. Li/Li⁺ the anodic charge of 390 mC (51 mAh/g) and the cathodic charge of 337 mC (44 mAh/g). A comparative test with carbon-coated LiFePO₄ (Nanomyte BE-20, NEI) cannot be carried out due to negligible activity of this electrode at the C/5 rate. Even at ten times slower charging, this carbon-coated electrode exhibits much worse performance (curve B in FIG. 10, right chart).

The applied amount of working solution Z-907Na/SWCNT (1.5 mL; 6×10⁻⁴ mol/L Z-907Na) gives the upper limit of the adsorbed Z-907Na to be 0.9 μmol and the amount of adsorbed carbon (in the form of SWCNT) to be 6.3 μmol per 200 mg of LiFePO₄ (See Experimental Section). The concentration of elemental carbon from SWCNT was, therefore, less than 0.04 wt % in the final solid material). From the BET surface area of LiFePO₄ we can calculate that the surface coverage of Z-907Na is equivalent to about one molecule per 2 nm². This is not far from the monolayer coverage, if we take into account the usual dimensions of Ru-bipyridine molecules ^{[22]}.

The unprecedented activity of the electrode composite of LiFePO₄/Z-907Na/SWCNT is obviously due to the presence of carbon nanotubes, which can quickly transport the charge mediated by Z-907Na complex towards the olivine surface. This beneficial role of carbon nanotubes even promotes the cathodic process. This is almost absent in sole molecular wiring, due to low driving force of the redox process in Z-907Na for the reduction of Li₁₋ₓFePO₄ back to the starting stoichiometric composition (FIG. 9).

### REFERENCE LIST NANOTUBE WIRING

[1] A. K. Padhi, K. S, Nanjundasawamy, J. B. Goodenough, J. Electrochem. Soc. 1997, 144, 1188-1194.
[2] C. Delacourt, L. Laffont, R. Bouchet, C. Wurm, J. B. Leriche, M. Mocrette, J. M. Tarascon, C. Masquelier, J. Electrochem. Soc. 2005, 153, A913-A921.
[3] P. S. Herle, B. Ellis, N. Coombs, L. F. Nazar, Nature Mat. 2004, 3, 147-152.
[4] M. Yonemura, A. Yamada, Y. Takei, N. Sonoyama, R. Kanno, J. Electrochem. Soc. 2004, 151, A1352-A1356.
[5] F. Zhou, K. Kang, T. Maxisch, G. Ceder, D. Morgan, Solid State Comm. 2004, 132, 181-186.
[6] B. Ellis, L. K. Perry, D. H. Ryan, L. F. Nazar, J. Am. Chem. Soc. 2006, 128.
[7] R. Dominko, M. Bele, M. Gaberseck, M. Remskar, D. Hanzel, J. M. Goupil, S. Pejovnik, J. Jamnik, J. Power Sources 2006, 153, 274-280.
[8] T. Nakamura, Y. Miwa, M. Tabuchi, Y. Yamada, J. Electrochem. Soc. 2006, 153, A1108-A1114.
[9] J. Ma, Z. Qin, J. Power Sources 2005, 148, 66-71.
[10] N. H. Kwon, T. Drezen, I. Exnar, I. Teerlinck, M. Isono, M. Grätzel, Electrochem. Solid State Lett. 2006, 9, A277-A280.
[11] A. Yamada, M. Hosoya, S. C. Chung, Y. Kudo, K. Hinokuma, K. Y. Liu, Y. Nishi, J. Power Sources 2003, 119-121, 232-238.
[12] G. L1, H. Azuma, M. Tohda, Electrochem. Solid State Lett. 2002, 5, A135-A137.
[13] C. Delacourt, P. Poizot, M. Morcrette, J. M. Tarascon, C. Masquelier, Chem. Mater. 2004, 16, 93-99.
[14] S. Y. Chung, J. T. Bloking, Y. M. Chiang, Nature Mat. 2002, 1, 123-128.
[15] D. Wang, H. Li, Z. Wang, X. Wu, Y. Sun, X. Huang, L. Chen, J. Solid State Chem. 2004, 177, 4582-4587.
[16] P. Wang, B. Wenger, R. Humphry-Baker, J. Moser, J. Teuscher, W. Kantlehner, J. Mezger, E. V. Stoyanov, S. M. Zakeeruddin, M. Grätzel, J. Am. Chem. Soc. 2005, 127, 6850-6856.
[17] D. A. Britz, A. N. Khlobystov, Chem. Soc. Rev. 2006, 35, 637-659.
[18] S. W. Boettcher, M. H. Bartl, J. G. Hu, G. D. Stucky, J. Am. Chem. Soc. 2005, 127, 9721-9730.
[19] Q. Wang, S. M. Zakeeruddin, M. K. Nazeeruddin, R. Humphry-Baker, M. Grätzel, J. Am. Chem. Soc. 2006, 128, 4446-4452.
[20] Q. Wang, N. Evans, S. M. Zekeeruddin, I. Exnar, M. Grätzel, J. Am. Chem. Soc. 2006.
[21] P. Wang, S. M. Zakeeruddin, P. Comte, R. Charvet, R. Humphry-Baker, M. Grätzel, J. Phys. Chem. B 2003, 107, 14336-14341.
[22] M. K. Nazeeruddin, P. Pechy, T. Renouard, S. M. Zakeeruddin, R. Humphry-Baker, P. Comte, P. Liska, L. Cevey, E. Costa, V. Shklover, L. Spiccia, G. B. Deacon, C. A. Bignozzi, M. Grätzel, J. Am. Chem. Soc. 2001, 123, 1613-1624.

1. A rechargeable electrochemical cell with improved energy density comprising cathodic or anodic lithium insertion materials with p- or n-type redox active compounds, said electrochemical cell comprising two compartments separated by a separating element, the first compartment containing said cathodic lithium insertion material and said p-type redox active compounds dissolved in an electrolyte, the second compartment containing said anodic lithium insertion material and said n-type redox active compound dissolved in an electrolyte, said separating element being permeable for lithium ions and impermeable for said p- or n-type redox active compounds.

2. A rechargeable electrochemical cell according to claim 1 wherein
(a) The first oxidation potential of the p-type redox active compound matches at least the cathodic lithium insertion material, the cathodic electrode comprising cathodic lithium insertion material, binder, conductive additives.
(b) The first reduction potential of the n-type redox active compound matches at least the anodic lithium insertion material, the anodic electrode comprising anodic lithium insertion material, binder, conductive additives.

3. A rechargeable electrochemical cell according to claim 2, wherein the nano- or sub-micrometer sized cathodic lithium insertion material is selected from doped or non-doped oxides LiMO₂ where M is one or more elements selected from M=Co, Ni, Mn, Fe, W, V, LiV₃O₈ and mix of them; phosphor-olivines as LiMPO₄ where M is one or more elements selected from with M=Fe, Co, Mn, Ni, VO, Cr and mix of them and spinels and mixed spinels as LiₓMn₂O₄ or Li₂CoₓFe_{y}Mn_{z}O₈, etc.

4. A rechargeable electrochemical cell according to claim 2, wherein the nano- or sub-micrometer sized anodic lithium insertion material is selected from carbon, TiO₂, Li₄Ti₅O₁₂, SnO₂, SnO, Si, etc.

5. A rechargeable electrochemical cell according to claim 2, wherein the particle size of the lithium insertion materials ranges from 10 nm to 10 μm.

6. A rechargeable electrochemical cell according to claim 2, wherein the separating element is Lithium Phosphorus Oxynitride (LiPON) or 70Li₂S.30P₂S₅, or a ceramic ultrafiltration membrane whose pore radius is selected such that it is impermeable to the redox active compound but permeable to the smaller lithium ions, or a perforated polymer membrane made whose pores have again a specific size to allow passage of lithium ions but to prevent the permeation of the redox active compound.

7. A rechargeable electrochemical cell according to claim 1 wherein p- or n-type redox active compounds are polymer compounds.

8. A rechargeable electrochemical cell according to claim 7 wherein said polymer is a composition of a redox active molecule attached to the polymer backbone, either by covalent bonding or quaternization

9. A rechargeable electrochemical cell according to claim 7 wherein said polymer is also acting as a binder.

10. A rechargeable electrochemical cell according to claim 8, wherein the redox active compounds are an organic compound selected from equation (1)
D-π(Ral)_{q-} (1)
wherein π represents schematically the π system of the aforesaid substituent, Ral represents an aliphatic substituent with a saturated chain portion bound to the π system, and wherein q represents an integer, indicating that π may bear more than one substituent Ral.
The π system π may be an unsaturated chain of conjugated double or triple bonds of the type 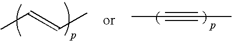
wherein p is an integer from 0 to 20.
or an aromatic group Rar of from 6 to 22 carbon atoms, or a combination thereof.
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1, 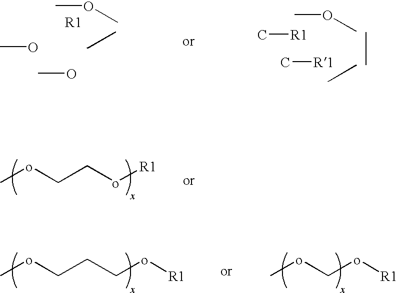
wherein R1, R′1 is an alkyl from 1 to 10 carbon atoms, x≧0 and 0<n<5.
According to a preferred embodiment, D is selected from structures of formula (1-11) given below: 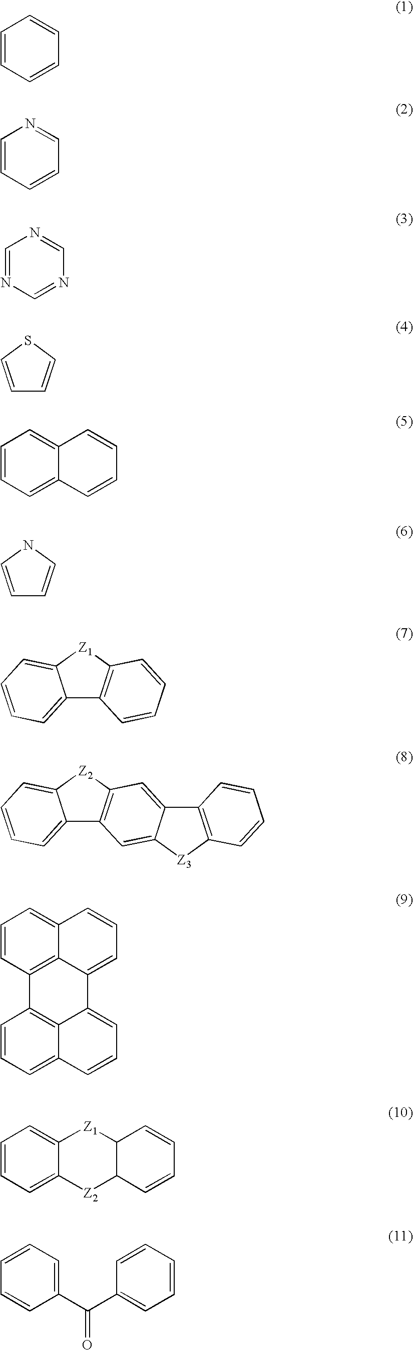
in which each of Z¹, Z² and Z³ is the same or different and is selected from the group consisting of O, S, SO, SO₂, NR¹, N⁺(R¹)(^{1″}), C(R²)(R³), Si(R^{2′})(R^{3′}) and P(O)(R⁴), wherein R¹, R^{1′} and R^{1″} are the same or different and each is selected from the group consisting of hydrogen atoms, alkyl groups, haloalkyl groups, alkoxy groups, alkoxyalkyl groups, aryl groups, aryloxy groups, and aralkyl groups, which are substituted with at least one group of formula —N⁺(R⁵)₃ wherein each group R⁵ is the same or different and is selected from the group consisting of hydrogen atoms, alkyl groups and aryl groups, R², R³, R^{2′} and R^{3′} are the same or different and each is selected from the group consisting of hydrogen atoms, alkyl groups, haloalkyl groups, alkoxy groups, halogen atoms, nitro groups, cyano groups, alkoxyalkyl groups, aryl groups, aryloxy groups and aralkyl groups or R² and R³ together with the carbon atom to which they are attached represent a carbonyl group, and R⁴ is selected from the group consisting of hydrogen atoms, alkyl groups, haloalkyl groups, alkoxyalkyl groups, aryl groups, aryloxy groups and aralkyl groups.

11. According to claim 10, preferred embodiments of structure (10) for D may be selected from structures (12) and (13) given below:

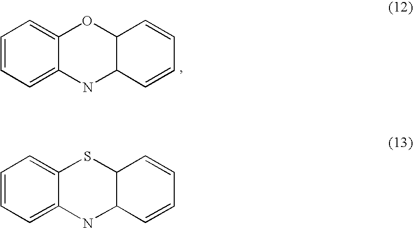

12. The rechargeable electrochemical cell according to claim 8, wherein the redox active compound is a metal complex selected from formula (5) to (8).
MeL1L(Z)₂ (5)
MeL2LZ (6)
MeL1(L2)(L3) (7)
Me(L1)(L2) (8)
The resulting metal complex of Me selected from the group of Ru, Os and Fe comprising L, L1, L2, L3, and Z as described herein before, said complex
being of formula (5) if L and L1 are the same or different from a compound of formulas (15), (16), (18), (20), (21), (22), (23), (24), (25), (26), (27) or (28).
being of formula (6) if L is from a compound of formula (15), (16), (18), (20), (21), (22), (23), (24), (25), (26), (27) or (28) and L2 is a compound of formula (17) or (19), wherein Z is selected from the group consisting of H₂O, Cl, Br, CN, NCO, NCS and NCSe.
being of formula (7), wherein L1, L2 and L3 are the same or different from a compound of formula (14), (15), (16), (18), (20), (21), (22), (23), (24), (25), (26), (27) or (28)
being of formula (8), wherein L1 and L2 may be same or different, and at least one of substituents R, R′, R″ comprises a π system in conjugated relationship with the π system of the tridentate structure of formulae (17) to (19). 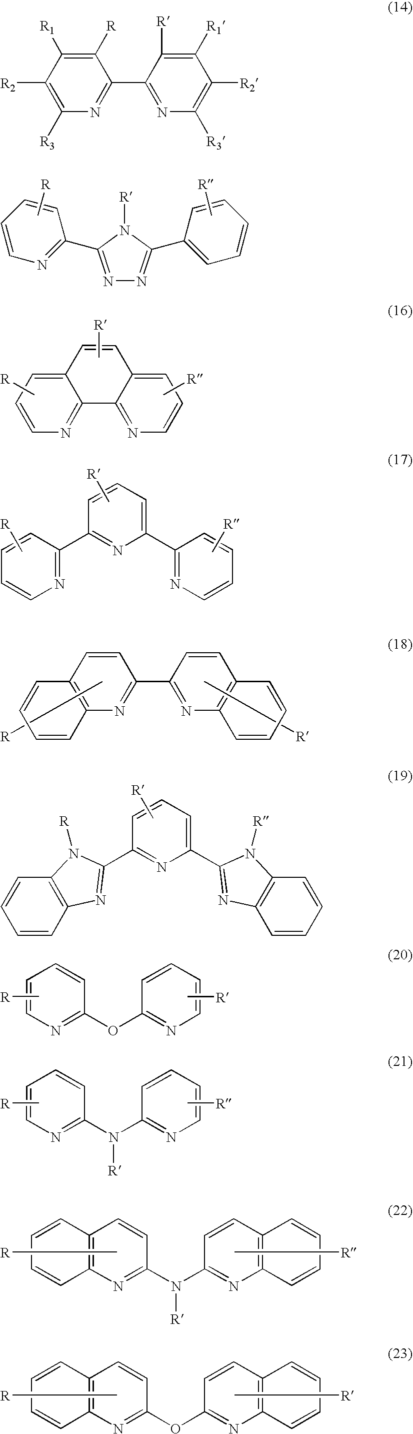 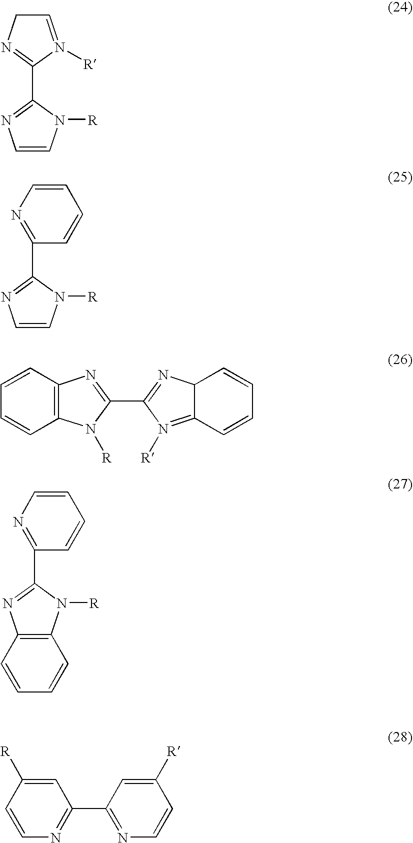
wherein at least one of the substituents —R, —R₁, —R₂, —R₃,
—R′, —R₁′, —R₂′, —R₃′, —R″ is of formula (2), (3) or (4) 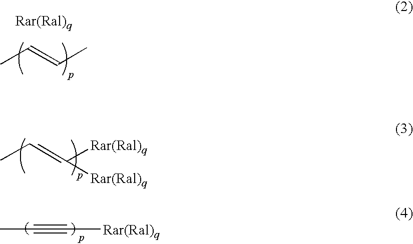
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1, 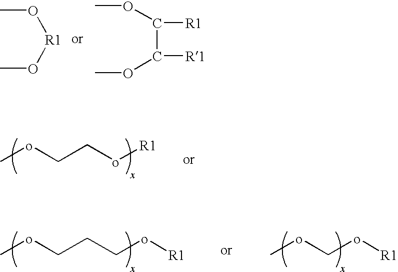
wherein R1, R′1 is an alkyl from 4 to 10 carbon atoms, x≧0, and 0<n<5 and
wherein the other one(s) of substituent(s) —R, —R₁, —R₂, —R₃, —R′, —R₁′, —R₂′, —R₃′, —R″ is (are) the same or a different substituents of formula (1), (2) or (3), or is (are) selected from —H, —OH, —R₂, —OR₂ or —N(R₂)₂, wherein R₂ is an alkyl of 1 to 20 carbon atoms.

13. The rechargeable electrochemical cell according to claim 7, wherein the polymer is selected from polyvinyl pyridine, polyvinyl imidazole, polyethylene oxide, polymethylmethacrylate, polyacrylonitrile, polypropylene, polystyrene, polybutadiene, polyethyleneglycol, polyvinylpyrrolidone, polyaniline, polypyrrole, polythiophene and their derivatives.

14. The rechargeable electrochemical cell according to claim 7 wherein the redox active polymer is Poly(4-(-(10-(12′-dodecyl phenoxazine)pyridinium)-co-4-vinylpyridine.

15. A rechargeable electrochemical cell according to claim 1 wherein p- or n-type redox active compounds are attached with SWCNT.

16. A rechargeable electrochemical cell according to claim 15 wherein the redox active compounds are attached to the SWCNT either by covalent bonding, non-covalent bonding or electrostatic interaction.

17. A rechargeable electrochemical cell according to claim 16 wherein the redox active compounds are an organic compound selected from equation (1)
D-π(Ral)_{q}- (1)
wherein π represents schematically the π system of the aforesaid substituent, Ral represents an aliphatic substituent with a saturated chain portion bound to the π system, and wherein q represents an integer, indicating that π may bear more than one substituent Ral.
The π system π may be an unsaturated chain of conjugated double or triple bonds of the type 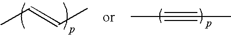
wherein p is an integer from 0 to 20.
or an aromatic group Rar of from 6 to 22 carbon atoms, or a combination thereof.
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1, 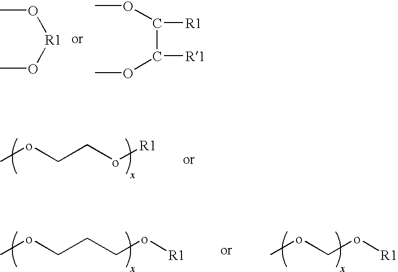
wherein R1, R′1 is an alkyl from 1 to 10 carbon atoms, x≧0 and 0<n<5.
D is selected from structures of formula (1-11) given below: 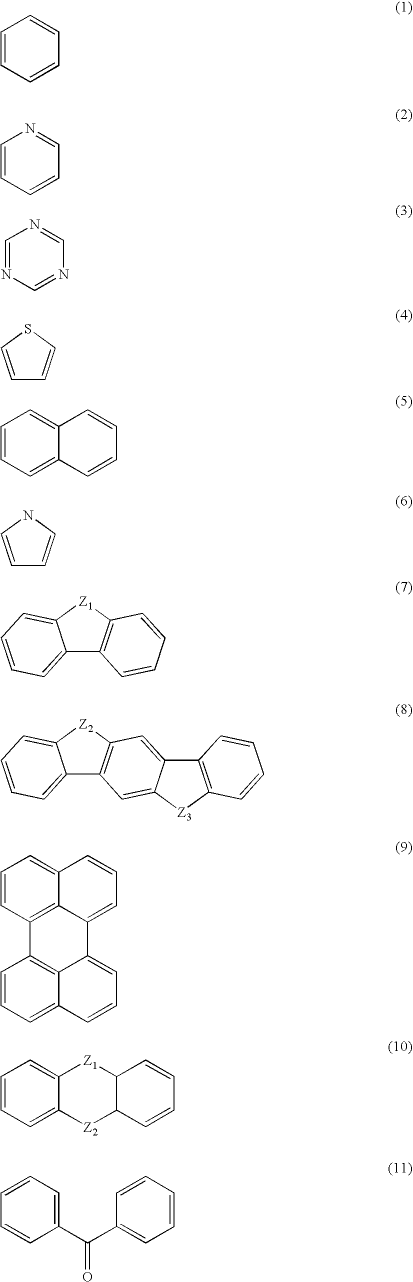
in which each of Z¹, Z² and Z³ is the same or different and is selected from the group consisting of O, S, SO, SO₂, NR¹, N⁺(R^{1′})(^{1″}), C(R²)(R³), Si(R^{2′})(R^{3′}) and P(O)(OR⁴), wherein R¹, R^{1′} and R^{1″} are the same or different and each is selected from the group consisting of hydrogen atoms, alkyl groups, haloalkyl groups, alkoxy groups, alkoxyalkyl groups, aryl groups, aryloxy groups, and aralkyl groups, which are substituted with at least one group of formula —N⁺(R⁵)₃ wherein each group R⁵ is the same or different and is selected from the group consisting of hydrogen atoms, alkyl groups and aryl groups, R², R³, R^{2′} and R^{3′} are the same or different and each is selected from the group consisting of hydrogen atoms, alkyl groups, haloalkyl groups, alkoxy groups, halogen atoms, nitro groups, cyano groups, alkoxyalkyl groups, aryl groups, aryloxy groups and aralkyl groups or R² and R³ together with the carbon atom to which they are attached represent a carbonyl group, and R⁴ is selected from the group consisting of hydrogen atoms, alkyl groups, haloalkyl groups, alkoxyalkyl groups, aryl groups, aryloxy groups and aralkyl groups.

18. A rechargeable electrochemical cell according to claim 17 wherein structure (10) for D is selected from structures (12) and (13) given below:

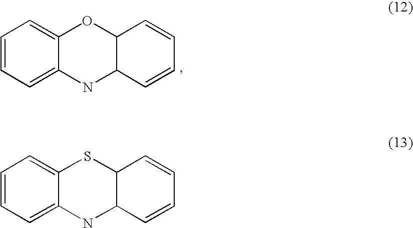

19. A rechargeable electrochemical cell according to claim 15 wherein the redox active compound is a metal complex selected from formula (5) to (8).
MeL1L(Z)₂ (5)
MeL2LZ (6)
MeL1(L2)(L3) (7)
Me(L1)(L2) (8)
The resulting metal complex of Me selected from the group of Ru, Os and Fe comprising L, L1, L2, L3, and Z as described herein before, said complex
being of formula (5) if L and L1 are the same or different from a compound of formulas (15), (16), (18), (20), (21), (22), (23), (24), (25), (26), (27) or (28).
being of formula (6) if L is from a compound of formula (15), (16), (18), (20), (21), (22), (23), (24), (25), (26), (27) or (28) and L2 is a compound of formula (17) or (19), wherein Z is selected from the group consisting of H₂O, Cl, Br, CN, NCO, NCS and NCSe.
being of formula (7), wherein L1, L2 and L3 are the same or different from a compound of formula (14), (15), (16), (18), (20), (21), (22), (23), (24), (25), (26), (27) or (28)
being of formula (8), wherein L1 and L2 may be same or different, and at least one of substituents R, R′, R″ comprises a π system in conjugated relationship with the π system of the tridentate structure of formulae (17) and (19). 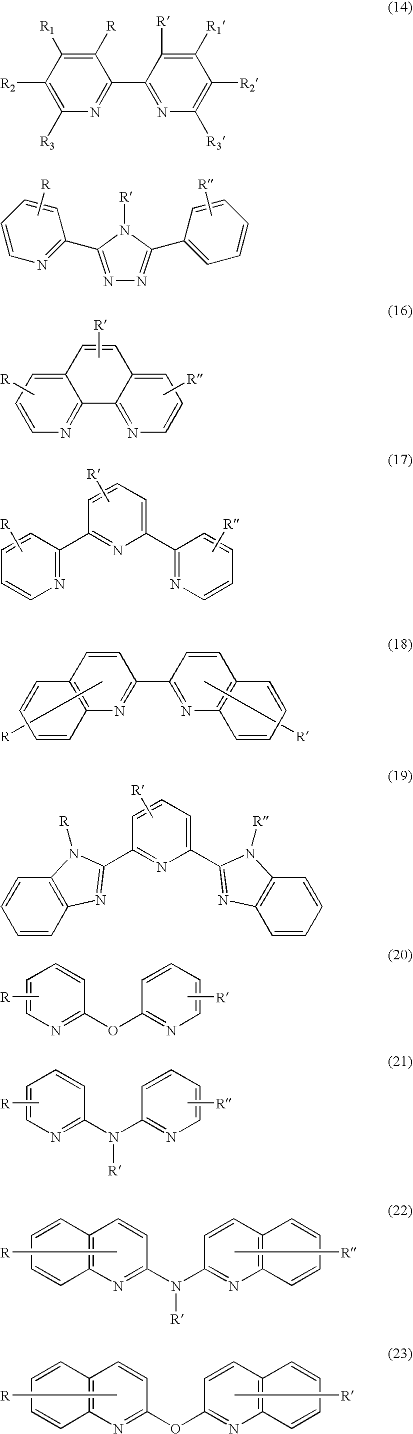 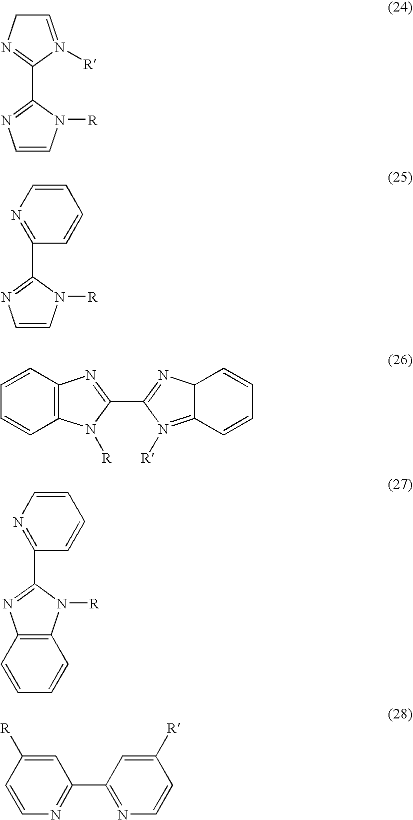
wherein at least one of the substituents —R, —R₁, —R₂, —R₃,
—R′, —R₁′, —R₂′, —R₃′, —R″ is of formula (2), (3) or (4) 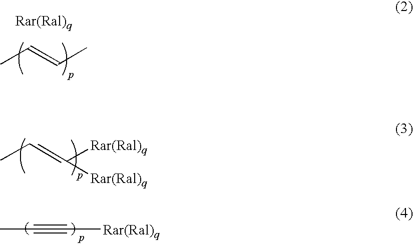
wherein p is an integer from 0 to 4,
wherein q is an integer from 0 to 4,
wherein Rar is a monocyclic or oligocyclic aryl from C6 to C22,
wherein -Ral is H, —R1, (—O—R1)ₙ, —N(R1)₂, —NHR1, 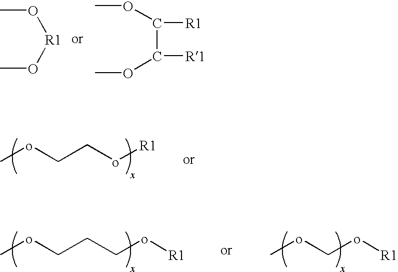
wherein R1, R′1 is an alkyl from 4 to 10 carbon atoms, x≧0, and 0<n<5 and
wherein the other one(s) of substituent(s) —R, —R₁, —R₂, —R₃, —R, —R₁′, —R₂′, —R₃′, —R″ is (are) the same or a different substituents of formula (1), (2) or (3), or is (are) selected from —H, —OH, —R₂, —OR₂ or —N(R₂)₂, wherein R₂ is an alkyl of 1 to 20 carbon atoms.
